(19) United States
(12) Patent Application Publication
(10) Pub. No.: US 2024/0253223 A1
(43) Pub. Date: Aug. 1, 2024

(54) OPERATION PLANNING DEVICE, OPERATION PLANNING METHOD, AND STORAGE MEDIUM

(71) Applicant: NEC Corporation, Minato- ku, Tokyo (JP)

(72) Inventors: Mineto SATOH, Tokyo (JP); Takuma KOGO, Tokyo (JP); Masatsugu OGAWA, Tokyo (JP)

(73) Assignee: NEC Corporation, Minato- ku, Tokyo (JP)

(21) Appl. No.: 18/290,027

(22) PCT Filed: May 17, 2021
(86) PCT No.: PCT/JP2021/018620

§ 371 Date: Nov. 9, 2023

(51) Int. Cl. B25J 9/16; B25J 5/00

(52) U.S. Cl. CPC B25J 9/1661; B25J 5/007; B25J 9/161

(57) ABSTRACT

The operation planning device 1X mainly includes a state setting means 31X and an operation planning means 16X. The state setting means 31X sets a state in a workspace where a mobile robot equipped with a manipulator handling a target object works. The operation planning means 16X determines an operation plan relating to a movement of the robot an operation of the manipulator, based on the state set by the state setting means 31X, a constraint condition relating to the movement of the robot and the operation of the manipulator, and an evaluation function based on dynamics of the robot.

### TECHNICAL FIELD

The present disclosure relates to the technical field of an operation planning device, an operation planning method, and storage medium for operation planning of a robot.

### BACKGROUND

Mobile working robots have been proposed. For example, Patent Literature 1 discloses a control unit configured to control each operation axis of a robot arm and each operation axis of a carriage when the operation axes of the robot arm provided on the carriage and the operation is axes of the carriage cooperatively operate.

### CITATION LIST

### Patent Literature

Patent Literature 1: Japanese Patent No. 6458052

### SUMMARY

### Problem to be Solved

In a mobile robot equipped with a manipulator, the movement of the robot main body and the operation of the manipulator affect each other, and it is difficult to formulate the plans of them simultaneously. On the other hand, when the movement of the robot main body and the operation of the manipulator are planned independently, inefficient plans could be calculated.

In view of the issues described above, it is an object of the present disclosure to provide an operation planning device, an operation planning method, and a storage medium capable of suitably determining an operation plan of a mobile robot equipped with a manipulator.

### Means for Solving the Problem

In one mode of the operation planning device, there is provided an operation planning device including:
a state setting means configured to set a state in a workspace where a mobile robot equipped with a manipulator handling a target object works; and
an operation planning means configured to determine an operation plan relating to a movement of the robot and an operation of the manipulator, based on
   the state,
   a constraint condition relating to the movement of the robot and the operation of the manipulator, and
   an evaluation function based on dynamics of the robot.

In another mode of the operation planning device, there is provided an operation planning device including:
an area designation means configured to receive designation of an area where a mobile robot equipped with a manipulator handling a target object works;
a target designation means configured to receive designation relating to the target object in the area; and
an operation planning means configured to determine an operation plan relating to a movement of the robot and an operation of the manipulator, based on the designation of the area and the designation relating to the target object.

In one mode of the operation planning method, there is provided an operation planning method executed by a computer, the operation planning method including:
setting a state in a workspace where a mobile robot equipped with a manipulator handling a target object works; and
determining an operation plan relating to a movement of the robot and an operation of the manipulator, based on
   the state,
   a constraint condition relating to the movement of the robot and the operation of the manipulator, and
   an evaluation function based on dynamics of the robot.

In another mode of the operation planning method, there is provided an operation planning method executed by a computer, the operation planning method including:
receiving designation of an area where a mobile robot equipped with a manipulator handling a target object works;
receiving designation relating to the target object in the area; and
determining an operation plan relating to a movement of the robot and an operation of the manipulator, based on the designation of the area and the designation relating to the target object.

In one mode of the storage medium, there is provided a storage medium storing a program executed by a computer, the program causing the computer to:
set a state in a workspace where a mobile robot equipped with a manipulator handling a target object works; and
determine an operation plan relating to a movement of the robot and an operation of the manipulator, based on
   the state,
   a constraint condition relating to the movement of the robot and the operation of the manipulator, and
   an evaluation function based on dynamics of the robot.

In another mode of the storage medium, there is provided a storage medium storing a program executed by a computer, the program causing the computer to:
receive designation of an area where a mobile robot equipped with a manipulator handling a target object works;
is receive designation relating to the target object in the area; and
determine an operation plan relating to a movement of the robot and an operation of the manipulator, based on the designation of the area and the designation relating to the target object.

### Effect

An example advantage according to the present invention is to suitably formulate an operation plan of a mobile robot equipped with a manipulator.

### BRIEF DESCRIPTION OF THE DRAWINGS

FIG. 1 It illustrates a configuration of a robot control system in a first example embodiment.

FIG. 2 It illustrates a hardware configuration of a robot controller.

FIG. 3 It illustrates an example of a data structure of application information.

FIG. 4 It illustrates an example of a functional block of the robot controller.

FIG. 5 It illustrates an example of functional blocks of an operation planning unit.

FIG. 6 It is an example of a schematic overhead view of the workspace of the robot.

FIG. 7 It is a diagram illustrating a reference point and a robot route.

FIG. 8 It is a bird's-eye view of an abstract state setting space.

FIG. 9 It is a diagram schematically illustrating the trajectory of the robot main body and the robot hand.

FIG. 10A is a diagram clearly illustrating the operation period of the robot main body and the operation period of the manipulator when the priority of safety is set.

FIG. 10B is a diagram clearly illustrating the operation period of the robot main body and the operation period of the manipulator when the priority of work time length is set.

FIG. 11 It illustrates a first display example of a task designation screen image for designating an objective task.

FIG. 12 It illustrates a second display example of a task designation screen image for designating an objective task.

FIG. 13 It illustrates an example of a flowchart illustrating an outline of a process to be executed by the robot controller 1 in the first example embodiment.

FIG. 14 It is a schematic configuration diagram of an operation planning device in a second example embodiment.

FIG. 15 It illustrates an example of a flowchart in the second example embodiment.

### Example Embodiments

Hereinafter, example embodiments of an operation planning device, an operation planning method, and a storage medium will be described with reference to the drawings.

### First Example Embodiment

(1) System Configuration

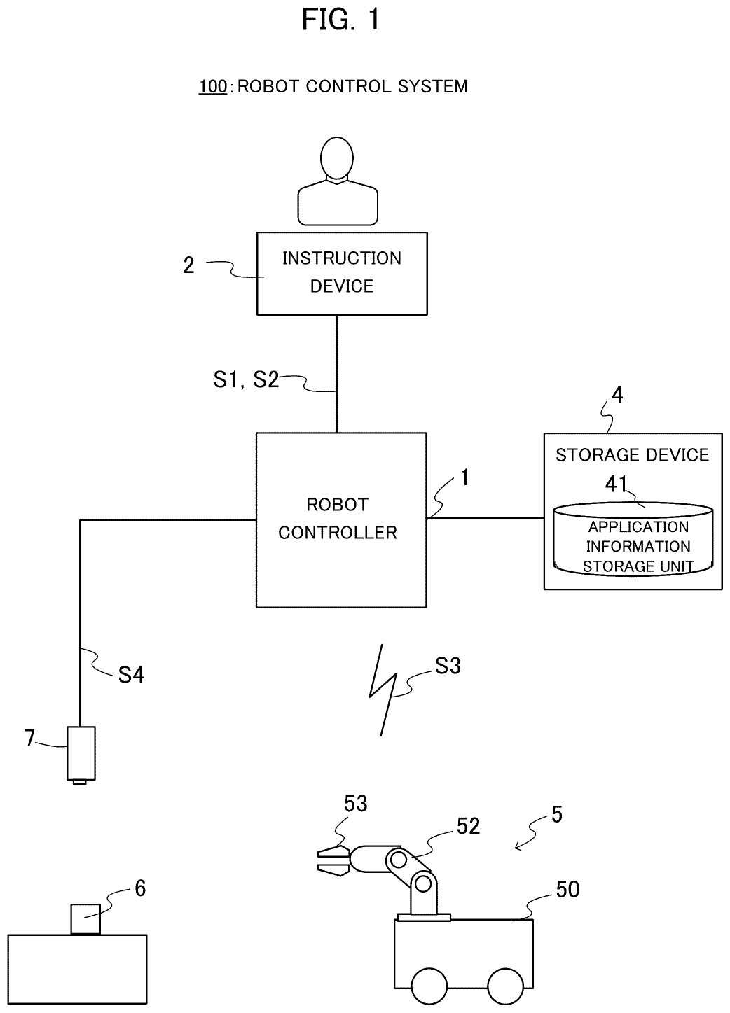

FIG. 1 illustrates a configuration of a robot control system 100 according to the first example embodiment. The robot control system 100 mainly includes a robot controller 1, an instruction device 2, a storage device 4, a robot 5, and a sensor 7.

When a task (also referred to as “objective task”) to be executed by the robot 5 is designated, the robot controller 1 converts the objective task into a time step sequence of tasks each of which is a simple task that the robot 5 can accept, and controls the robot 5 based on the generated sequence.

In addition, the robot controller 1 performs data communication with the instruction device 2, the storage device 4, the robot 5, and the sensor 7 through a communication network or by wireless or wired direct communication. For example, the robot controller 1 receives an input signal “S1” relating to the operation plan of the robot 5 from the instruction device 2. Further, the robot controller 1 causes the instruction device 2 to perform a predetermined display or audio output by transmitting an output control signal “S2” to the instruction device 2. Furthermore, the robot controller 1 transmits a control signal “S3” relating to the control of the robot 5 to the robot 5. The robot controller 1 also receives the sensor signal “S4” from the sensor 7.

The instruction device 2 is a device configured to receive an instruction to the robot 5 from the operator. The instruction device 2 performs a predetermined display or audio output based on the output control signal S2 supplied from the robot controller 1, or supplies an input signal S1 generated based on the operator's input to the robot controller 1. The instruction device 2 may be a tablet terminal equipped with an input unit and a display unit, or may be a stationary personal computer.

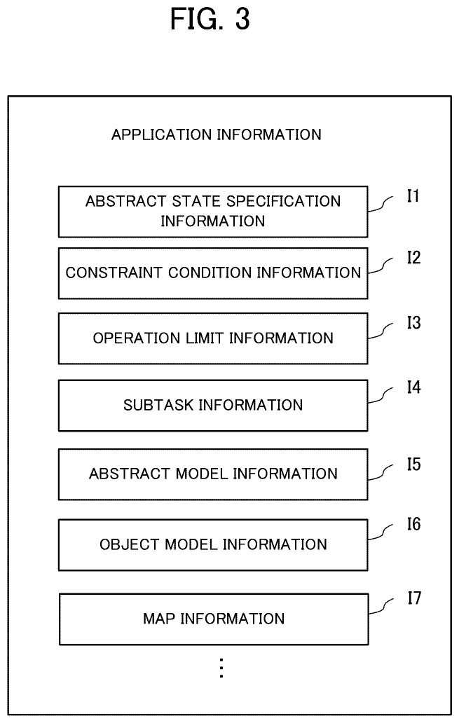

The storage device 4 includes an application information storage unit 41. The application information storage unit 41 stores application information necessary for generating to an operation sequence, which is a sequence of operations to be executed by the robot 5, from the objective task. Details of the application information will be described later with reference to FIG. 3. The storage device 4 may be an external storage device, such as a hard disk, connected or embedded in the robot controller 1, or may be a storage medium, such as a flash memory. The storage device 4 may be a server device that performs data communication with the robot controller 1 via a communication network. In this case, the storage device 4 may be configured by a plurality of server devices.

The robot 5 is a mobile (self-propelled) robot that performs the work relating to the objective task based on the control signal S3 supplied from the robot controller 1. FIG. 1 illustrates, as an example, a state in which the robot 5 performs pick-and-place operation of a target object (workpiece) 6. The robot 5 is, for example, a robot that performs an operation in an assembly factory, a food factory or any other factory or in logistics sites. The robot 5 is equipped with a robot main body 50 which moves, and a manipulator (in this case, a robot arm) 52 having a robot hand (end effector) 53. The manipulator 52 may be a vertical articulated robot, a horizontal articulated robot, or any other type of a robot. Hereinafter, the manipulator 52 is assumed to be synonymous with a robot arm. The robot 5 may supply a state signal indicating the state of the robot 5 to the robot controller 1. The state signal may be an output signal from one or more sensors for detecting the state (e.g., position and angle) of the entire robot 5 or specific parts such as a joint, or may be a signal indicating the progress of the operation sequence of the robot 5 generated by a control unit of the robot 5.

It is noted that the robot 5 does not necessarily include the robot main body 50 integrated with the manipulator 52, and the robot main body 50 and the manipulator 52 may be separate devices. For example, the manipulator 52 may be mounted on a mobile robot corresponding to the robot main body 50.

The sensor 7 is one or more sensors to detect a state of the workspace in which the objective task is performed such as a camera, a range sensor, a sonar and any combination thereof. In the example embodiment, it is assumed that the sensor 7 includes at least one camera for imaging the workspace of the robot 5. The sensor 7 supplies the generated sensor signal S4 to the robot controller 1. The sensor 7 may be a self-propelled or flying sensor (including a drone) that moves in the workspace. The sensors 7 may also include one or more sensors provided on the robot 5, one or more sensors provided on other objects existing in the workspace, and the like. The sensor 7 may also include a sensor that detects sound in the workspace. As such, the sensor 7 may include a variety of sensors that detect the state of the workspace, and may include sensors provided at any location.

The configuration of the robot control system 100 shown in FIG. 1 is an example, and various changes may be made to the configuration. For example, there may be plural robots 5, or the robot 5 may be equipped with plural manipulators 52 each of which operates independently. Even in these cases, the robot controller 1 generates an operation sequence to be executed for each robot 5 (and each of robot main body 50 and manipulator 52) based on the objective task, and transmits the control signal S3 based on the operation sequence to the robot 5. Further, the robot 5 may perform cooperative work with other robots, workers, or machine tools that operate in the workspace. The sensor 7 may also be a part of the robot 5. The instruction device 2 may be configured as a single device integrated with the robot controller 1. Further, the robot controller 1 may be configured by a plurality of devices. In this case, the plurality of devices constituting the robot controller 1 exchange information necessary to execute the processing assigned in advance, among this plurality of devices. Further, the robot controller 1 and the robot 5 may be integrally configured.
(2) Hardware Configuration

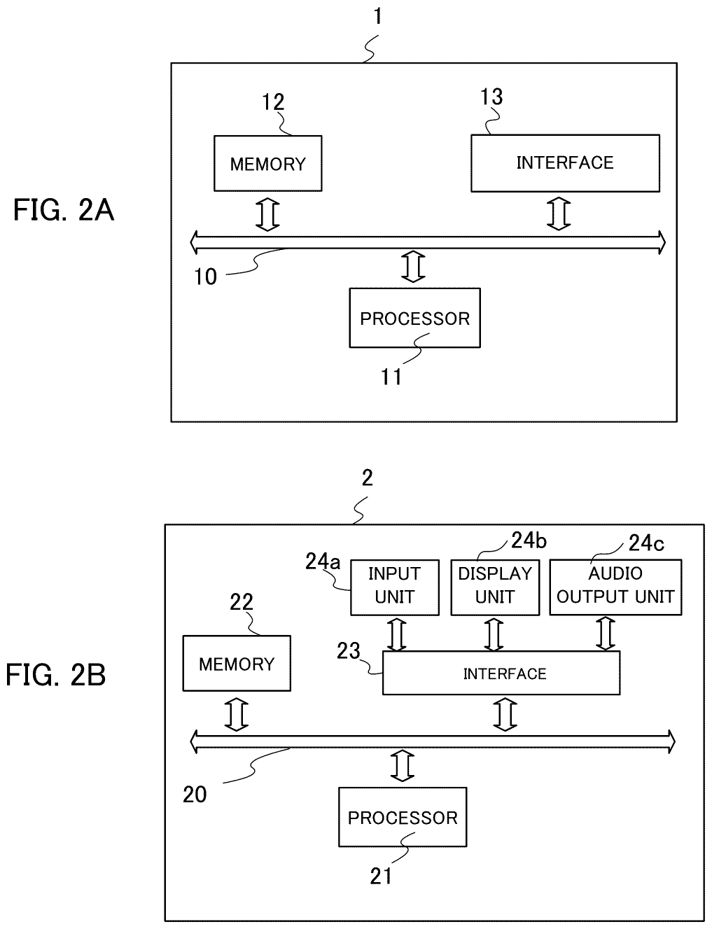

FIG. 2A shows a hardware configuration of the robot controller 1. The robot controller 1 includes a processor 11, a memory 12, and an interface 13 as hardware. The processor 11, memory 12 and interface 13 are connected to one another via a data bus 10.

The processor 11 executes a program stored in the memory 12 to function as a controller (arithmetic unit) for performing overall control of the robot controller 1. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by a variety of volatile and non-volatile memories, such as a RAM (Random Access Memory), a ROM (Read Only Memory), and a flash memory. Further, in the memory 12, a program for executing a process executed by the robot controller 1 is stored. A part of the information stored in the memory 12 may be stored in one or a plurality of external storage devices (e.g., the storage device 4) capable of communicating with the robot controller 1, or may be stored in a storage medium detachable from the robot controller 1.

The interface 13 is one or more interfaces for electrically connecting the robot controller 1 to other devices. Examples of these interfaces include a wireless interface, such as a network adapter, for transmitting and receiving data to and from other devices wirelessly, and a hardware interface, such as a cable, for connecting to other devices.

The hardware configuration of the robot controller 1 is not limited to the configuration shown in FIG. 2A. For example, the robot controller 1 may be connected to or incorporate at least one of a display device, an input device, and/or an audio output device. The robot controller 1 may be configured to include at least one of the instruction device 2 and/or the storage device 4.

FIG. 2B shows the hardware configuration of the instruction device 2. The instruction device 2 includes, as hardware, a processor 21, a memory 22, an interface 23, an input unit 24a, a display unit 24b, and an audio output unit 24c. The processor 21, memory 22 and interface 23 are connected to one another via a data bus 20. Further, the interface 23 is connected to the input unit 24a and the display unit 24b and the audio output unit 24c.

The processor 21 executes a predetermined process by executing a program stored in the memory 22. The processor 21 is a processor such as a CPU and a GPU. The processor 21 receives the signal generated by the input unit 24a via the interface 23, and generates an input signal S1 to transmit the input signal S1 to the robot controller 1 via the interface 23. Further, the processor 21 controls at least one of the display unit 24b and/or the audio output unit 24c, based on the display control signal S2 received from the robot controller 1 via the interface 23.

The memory 22 is configured by various volatile and non-volatile memories such as a RAM, a ROM, a flash memory, and the like. Further, in the memory 22, a program for executing a process to be executed by the instruction device 2 is stored.

The interface 23 is one or more interfaces for electrically connecting the instruction device 2 to other devices. Examples of these interfaces include a wireless interface, such as a network adapter, for transmitting and receiving data to and from other devices wirelessly, and a hardware interface, such as a cable, for connecting to other devices. Further, the interface 23 performs interface operation of the input unit 24a, the display unit 24b, and the audio output unit 24c. The input unit 24a is one or more interfaces that receive input from a user, and examples of the input unit 24a include a touch panel, a button, a keyboard, and a voice input device. Examples of the display unit 24b include a display and projector and it displays information under the control of the processor 21. Examples of the audio output unit 24c include a speaker, and it performs audio output under the control of the processor 21.

The hardware configuration of the instruction device 2 is not limited to the configuration shown in FIG. 2B. For example, at least one of the input unit 24a, the display unit 24b, and/or the audio output unit 24c may be configured as a separate device that electrically connects to the instruction device 2. The instruction device 2 may also be connected to various devices such as a camera, and may incorporate them.
(3) Application Information

Next, a data structure of the application information stored in the application information storage unit 41 will be described.

FIG. 3 shows an example of the data structure of the application information. As shown in FIG. 3, the application information includes abstract state specification information I1, constraint condition information 12, operation limit information 13, subtask information 14, abstract model information I5, object model information 16, and map information 17.

The abstract state specification information I1 specifies abstract states to be defined in order to generate the subtask sequence. The above-mentioned abstract states are abstract states of objects existing in the workspace, and are defined as propositions to be used in the target logical formula to be described later. For example, the abstract state specification information I1 specifies the abstract states to be defined for each type of objective task.

The constraint condition information 12 indicates constraint conditions of performing the objective task. The constraint condition information 12 indicates, for example, a constraint that the robot 5 must not be in contact with an obstacle when the objective task is pick-and-place, and a constraint that the robot 5 (manipulators) must not be in contact with each other, and the like. The constraint condition information 12 may be information in which the constraint conditions suitable for each type of the objective task are recorded.

The operation limit information 13 is information on the operation limit of the robot 5 to be controlled by the robot controller 1. For example, the operation limit information 13 is information on the upper limit of the speed, acceleration, or the angular velocity of the robot 5. The operation limit information 13 includes information stipulating the operation limit for each movable portion or joint (including robot main body 50) of the robot 5. In the present example embodiment, the operation limit information 13 includes information regarding the reach range of the manipulator 52. The reach range of the manipulator 52 is a range in which the manipulator 52 can handle the target object 6. The reach range may be indicated by the maximum distance from the reference position of the robot 5, or may be indicated by a region in a coordinate system with reference to the robot 5.

The subtask information 14 indicates information on subtasks being a possible component of the operation sequence. The term “subtask” indicates a task into which the objective task is resolved (broken down) in units which can be accepted by the robot 5 and indicates a segment operation of the robot 5. For example, when the objective task is pick-and-place, the subtask information 14 defines a subtask “reaching” that is the movement of the manipulator 52, and a subtask “grasping” that is the grasping by the manipulator 52. Further, the subtasks corresponding to the movements of the robot main body 50 are also defined at least in the subtask information 14. The subtask information 14 may indicate information on subtasks that can be used for each type of objective task. It is noted that the subtask information 14 may include information on subtasks which require operation commands by external input.

The abstract model information I5 is information on an abstract model in which the dynamics in the workspace is abstracted. The abstract model is represented by a model in which real dynamics is abstracted by a hybrid system, as will be described later. The abstract model Information I5 includes information indicative of the switching conditions of the dynamics in the above-mentioned hybrid system. Examples of the switching conditions in the case of a pick-and-place, which requires the robot 5 to pick-up and move the target object 6 to be handled by the robot 5 to a predetermined position, include a condition that the target object 6 cannot be moved unless it is gripped by the robot 5. The abstract model information I5 includes information on an abstract model suitable for each type of the objective task.

The object model information 16 is information relating to an object model of each object existing in the workspace to be recognized from the sensor signal S4 generated by the sensor 7. Examples of the above-mentioned each object include the robot 5, an obstacle, a tool or any other target object handled by the robot 5, a working object other than the robot 5, and the like. For example, the object model information 16 includes: information which is necessary for the robot controller to recognize the type, the position, the posture, the ongoing (currently-executing) operation and the like of the above-described each object; and three-dimensional shape information such as CAD (Computer Aided Design) data for recognizing the three-dimensional shape of the each object. The former information includes the parameters of an inference engine obtained by training a machine-learning model that is used in a machine learning such as a neural network. For example, the above-mentioned inference engine is learned in advance to output the type, the position, the posture, and the like of an object shown in the image when an image is inputted thereto.

The map information 17 is information indicating a map (layout) in the workspace in which the robot 5 exists. For example, the map information 17 includes information indicating a movable range (passageway) within the workspace, information regarding locations (including size and range) of fixed objects such as walls, installations, stairs, and information regarding obstacles.

In addition to the information described above, the application information storage unit 41 may store various information relating to the generation process of the operation sequence and the generation process of the output control signal S2.
(4) Processing Overview

Next, a description will be given of the processing outline of the robot controller 1. Schematically, after moving the robot main body 50 to an area (also referred to as a “designated area”) designated based on the input signal S1, the robot controller 1 formulates the operation plan relating to the movement of the robot main body 50 and the operation plan of the manipulator 52 at the same time. Thus, the robot controller 1 causes the robot 5 to perform the objective task efficiently and reliably.

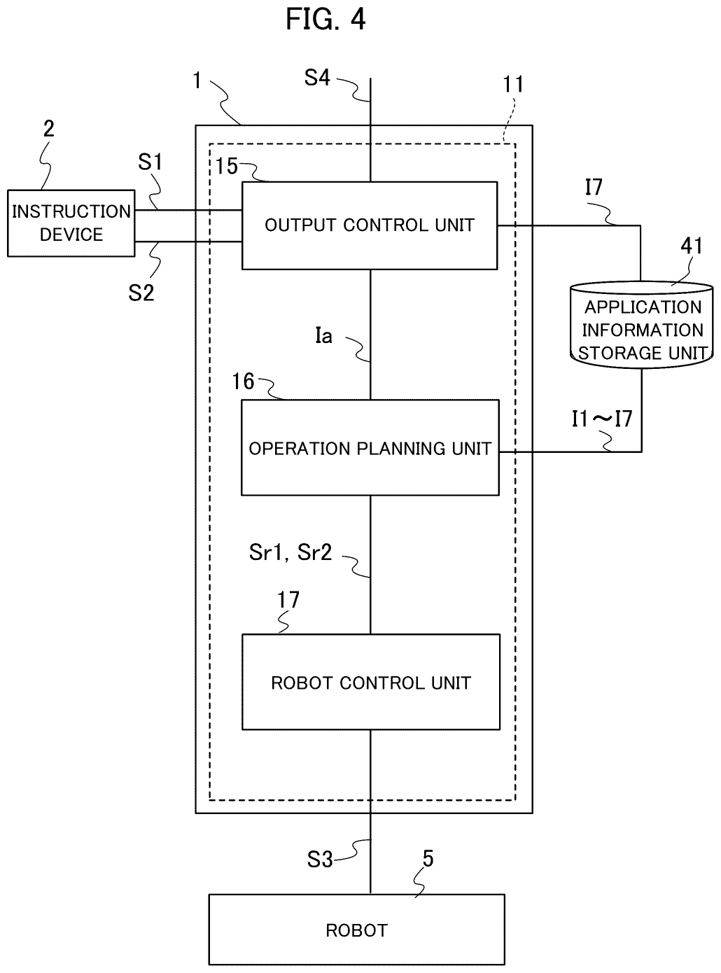

FIG. 4 is an example of a functional block illustrating a processing outline of the robot controller 1. The processor 11 of the robot controller 1 functionally includes an output control unit 15, an operation planning unit 16, and a robot control unit 17. In FIG. 4, although an example of data to be transferred between the blocks is shown, it is not limited thereto. The same applies to the drawings of other functional blocks described below.

The output control unit 15 generates, based on the map information 17 or the like, an output control signal S2 for causing the instruction device 2, which is used by the operator, to display or output by audio predetermined information and transmits the output control signal S2 to the instruction device 2 via the interface 13.

For example, the output control unit 15 generates an output control signal S2 for displaying an input screen image (also referred to as “task designation screen image”) relating to designation of an objective task on the instruction device 2. Thereafter, the output control unit receives the input signal S1 generated by the instruction device 2 through input operation on the task designation screen image from the instruction device 2 via the interface 13. In this instance, the input signal S1 contains information (also referred to as the “task designation information Ia”) which roughly specifies the objective task. The task designation information Ia is, for example, information corresponding to rough instructions to the robot 5 and does not include information (e.g., information regarding a control input or information regarding a subtask to be described later) that defines an exact operation of the robot 5. In the present exemplary example embodiment, the task designation information Ia includes at least information representing a designated area designated by the user as a space in which the robot 5 performs a task and information relating to the target object 6 (for example, an object to be grasped) designated by the user. The information relating to the target object 6 may include information indicating the position of each object to be the target object 6 and a transport destination (goal point) of each object to be the target object 6.

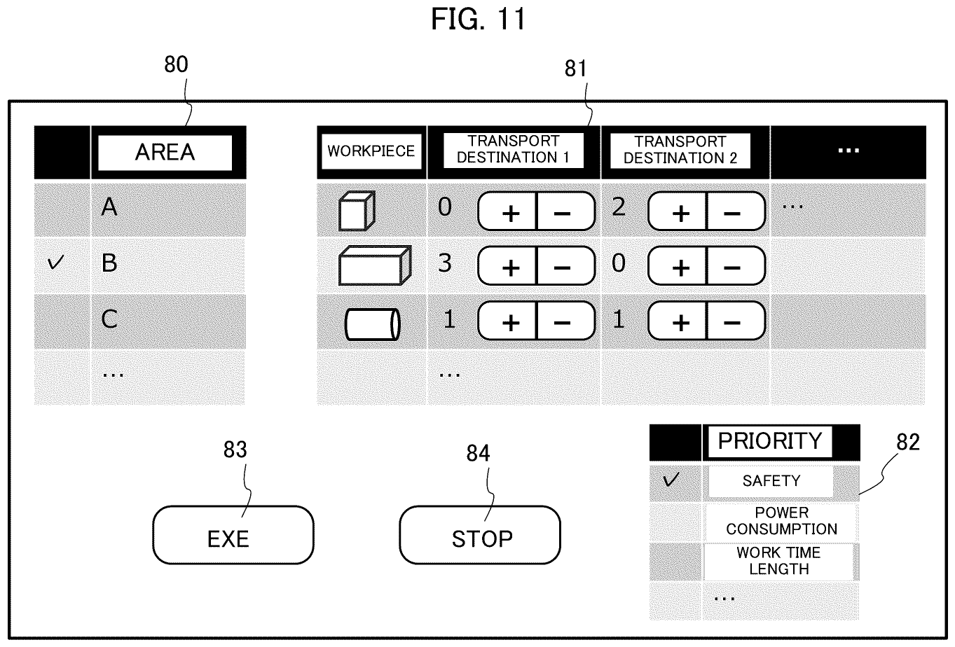

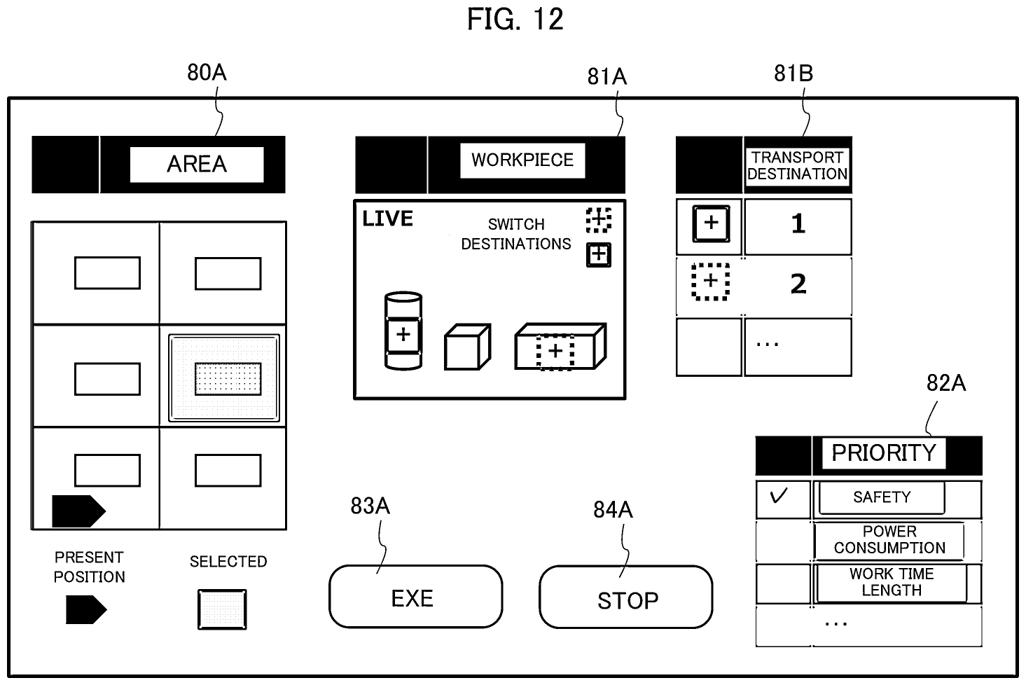

In some embodiments, the task designation information Ia may further include information specifying a matter of priorities in executing the objective task. A matter of priorities herein indicates a matter that should be emphasized in the execution of the objective task, such as the priority of safety, the priority of work time length, and the priority of power consumption. The priority is selected by the user, for example, in the task designation screen image. Specific examples of the designation method relating to the designated area, the target object 6, and the priority will be described later with reference to FIGS. 11 and 12.

The output control unit 15 supplies the task designation information Ia based on the input signal S1 supplied from the instruction device 2 to the operation planning unit 16.

The operation planning unit 16 generates an operation sequence to be executed by the robot 5 based on the task designation information Ia supplied from the output control unit 15, the sensor signal S4, and the application information stored in the storage device 4. The operation sequence corresponds to a sequence (subtask sequence) of subtasks that the robot 5 should execute to achieve the objective task, and defines a series of operations of the robot 5. In the present example embodiment, the operation planning unit 16 formulates a first operation plan that causes the robot 5 to arrive at the designated area indicated by the task designation informational Ia and a second operation plan that causes the robot 6 to complete the objective task after the robot 5 arrives at the designated area. Then, the operation planning unit 16 generates the first operation sequence “Sr1” based on the first operation plan and generates the second operation sequence “Sr2” based on the second operation plan. Then, the operation planning unit 16 sequentially supplies the generated first operation sequence Sr1 and the second operation sequence Sr2 to the robot controller 17. Each operation sequence herein includes information indicating the execution order and execution timing of each subtask.

The robot control unit 17 controls the operation of the robot 5 by supplying a control signal S3 to the robot 5 through the interface 13. When the operation sequence is received from the operation planning unit 16, the robot control unit 17 performs control for causing the robot 5 to execute subtasks constituting the operation sequence at predetermined execution timings (time steps), respectively. Specifically, the robot control unit 17 executes position control, torque control of the joint of the robot 5 for implementing the operation sequence by transmitting the control signal S3 to the robot 5.

The robot 5 may be equipped with functions of the robot controller 17 instead of the robot controller 1. In this case, the robot 5 executes operations based on the operation sequence generated by the operation planning unit 16. Further, plural robot control units 17 may be provided separately at the robot main body 50 and the manipulator 52. In this case, for example, the robot control units 17 may be configured in such a state where one of them is provided at the robot controller 1 and the other is provided at the robot 5.

Here, for example, each component of the output control unit 15, the operation planning unit 16 and the robot control unit 17 can be realized by the processor 11 executing a program. Additionally, the necessary programs may be recorded on any non-volatile storage medium and installed as necessary to realize each component. It should be noted that at least some of these components may be implemented by any combination of hardware, firmware, and software, or the like, without being limited to being implemented by software based on a program. At least some of these components may also be implemented by a user programmable integrated circuit such as a FPGA (Field-Programmable Gate Array) and a microcontroller. In this case, the integrated circuit may be used to realize a program functioning as the above components. At least some of the components may also be configured by an ASSP (Application Specific Standard Produce), an ASIC (Application Specific Integrated Circuit), or a quantum computer-controlled chip. Accordingly, each component may be implemented by any kind of hardware. The above is true for other example embodiments described later. Furthermore, each of these components may be implemented by the cooperation of a plurality of computers, for example, using cloud computing technology.
(5) Details of Operation Planning Unit

Next, a description will be given of a detailed process executed by the operation planning unit 16.
(5-1) Functional Blocks

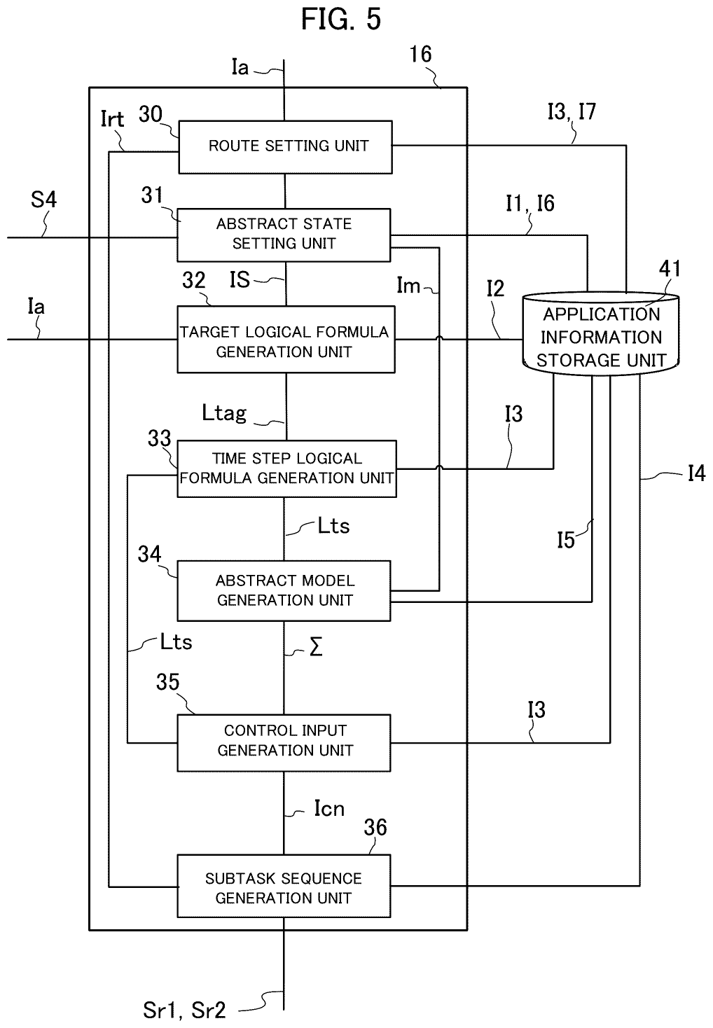

FIG. 5 is an example of a functional block diagram illustrating the functional configuration of the operation planning unit 16. The operation planning unit 16 functionally includes a route setting unit 30, an abstract state setting unit 31, a target logical formula generation unit 32, a time step logical formula generation unit 33, an abstract model generation unit 34, a control input generation unit 35, and a subtask sequence generation unit 36.

The route setting unit 30 sets a route of the robot 5, in formulating the first operation plan, for the robot 5 to reach a point (also referred to as a “reference point”) in the designated area indicated by the task designation information Ia. The reference point is set to be an appropriate position as an operation start position of the robot 5 to be used in formulating the second operation plan in which the second operation sequence Sr2 is generated. In other words, the route setting unit 30 sets the reference point to be an operation start position of the robot 5 suitable for formulating the second operation plan. For example, the route setting unit 30 sets a reference point on the basis of the positions of the designated area and the target object 6 indicated by the task designation information Ia, the self position of the robot 5 estimated based on the sensor signal S4 outputted by the sensor 7 provided in the robot 5, and the reach range of the robot 5 (more specifically, the manipulator 52) indicated by the operation limit information 13. Furthermore, the route setting unit 30 determines a route (also referred to as “robot route”) from the self position to the reference point, based on the self position obtained by the self position estimation, the reference point, and the map information 17. It is noted that the self position estimation may be based on a GPS receiver and internal sensors, or may be based on a camera or other external sensors such as a SLAM (Simultaneous Localization and Mapping). Specific examples of setting the reference point and the route will be described later. The route setting unit 30 supplies information (also referred to as “route information Irt”) indicating the set robot route to the subtask sequence generation unit 36.

In formulating the second operation plan, the abstract state setting unit 31 sets the abstract states of objects related to the objective task, on the basis of the sensor signal S4 supplied from the sensor 7, the task designation information Ia supplied from the output control unit 15, the abstract state specification information I1, and the object model information 16. In this instance, the abstract state setting unit 31 firstly determines a space (also referred to as “abstract state setting space”) for setting the abstract states, then recognizes the objects that needs to be considered when executing the objective task in the abstract state setting space to thereby generate a recognition result “Im” related to the objects. The abstract state setting space may be a whole designated area, or may be set to be a rectangular area in a designated area including at least the positions of the target object 6 specified in the task designation information Ia, the transport destination, and the robot 5. Based on the recognition result Im, the abstract state setting unit 31 defines propositions, to be expressed in logical formulas, of the abstract states that needs to be considered when executing the objective task, respectively. The abstract state setting unit 31 supplies information (also referred to as “abstract state setting information IS”) indicating the set abstract states to the target logical formula generation unit 32.

In formulating the second operation plan, the target logical formula generation unit 32 converts the objective task within the designated area indicated by the task designation information Ia into a logical formula (also referred to as “target logical formula Ltag”), in the form of a temporal logic, representing the final states to be achieved. In this case, the target logical formula generation unit 32 refers to the constraint condition information 12 from the application information storage unit 41 and adds the constraint conditions to be satisfied in executing the objective task within the designated area to the target logical formula Ltag. Then, the target logical formula generation unit 32 supplies the generated target logical formula Ltag to the time step logical formula generation unit 33.

In formulating the second operation plan, the time step logical formula generation unit 33 converts the target logical formula Ltag supplied from the target logical formula generation unit 32 into a logical formula (also referred to as “time step logical formula Lts”) representing to the states at every time step. The time step logical formula generation unit 33 supplies the generated time step logical formula Lts to the control input generation unit 35.

In formulating the second operation plan, the abstract model generation unit 34 generates an abstract model “Σ” in which the actual dynamics in the abstract state setting space is abstracted, on the basis of the abstract model information I5 stored in the application information storage unit 41 and the recognition result Im supplied from the abstract state setting unit 31. In this case, the abstract model generation unit 34 considers the target dynamics as a hybrid system in which continuous dynamics and discrete dynamics are mixed, and generates an abstract model Σ based on the hybrid system. The method of generating the abstract model Σ will be described later. The abstract model generation unit 34 supplies the generated abstract model Σ to the control input generation unit 35.

In formulating the second operation plan, the control input generation unit 35 generates a control input (i.e., the trajectory information regarding the robot 5) for each time step to be inputted to the robot 5. The control input generation unit 35 determines the control input to be inputted to the robot 5 for each time step, so as to satisfy the time step logical formula Lts supplied from the time step logical formula generation unit 33 and the abstract model Σ supplied from the abstract model generation unit 34 and optimize an evaluation function (e.g., a function representing the amount of energy consumed by the robot). In this case, the evaluation function is set to a function in which the dynamics of the robot 5 represented by the abstract model Σ is indirectly or directly considered. The control input generation unit 35 supplies information (also referred to as “control input information Icn”) indicating the control input to be inputted to the robot 5 for each time step to the subtask sequence generation unit 36.

The subtask sequence generation unit 36 generates the first operation sequence Sr1 in the case of formulating the first operation plan and generates the second operation sequence Sr2 in the case of formulating the second operation plan. If the route information Irt is already supplied from the route setting unit 30 at the time of formulating the first operation plan, the subtask sequence generation unit 36 generates the first operation sequence Sr1, which is a sequence of subtasks for instructing the robot 5 to move along the robot route indicated by the route information Irt, based on the subtask information 14. On the other hand, in formulating the second operation plan, the subtask sequence generation unit 36 generates the second operation sequence Sr2 related to the movement of the robot main body 50 and the operation of the manipulator 52, on the basis of the control input information Icn supplied from the control input generation unit 35 and the subtask information 14. The subtask sequence generation unit 36 sequentially supplies the generated operation sequences to the robot control unit 17.
(5-2) Route Setting Unit

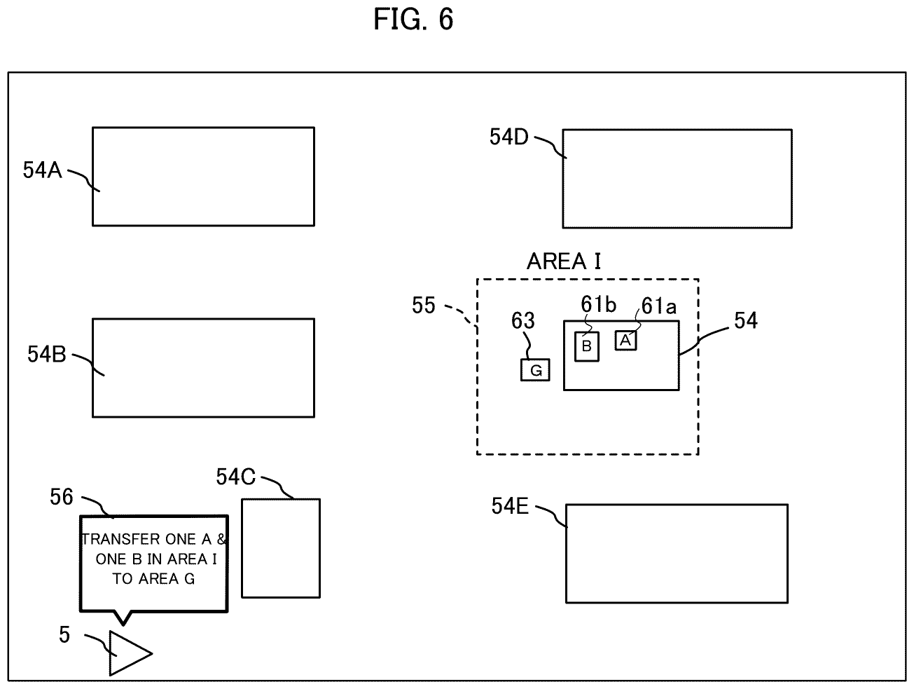

A specific description will be given of a process performed by the route setting unit 30. FIG. 6 is an example of a schematic view illustrating a workspace of the robot 5 in a bird's-eye view.

In the example shown in FIG. 6, in the workspace, there are a robot 5, a work table 54, and other work tables 54A to 54E other than the work table 54, and there are provided an object 61a (also referred to as “target object A”) and an object 61b (also referred to as “target object B”) on the work table 54. In addition, next to the work table 54, there is a second work table 63 (also referred to as a “transport destination G”) serving as a transport destination of the target object A and the target object B. Furthermore, for convenience of explanation, in FIG. 6, a word balloon 56 representing the schematic instructions specified by the user for the robot 5 is clearly shown. The schematic instructions is herein instructions, with clear indication of “area I” by the broken line frame 55 as the outer edge thereof, to move one target object A (i.e., the object 61a) and one target object B (i.e., the object 61b) to the transport destination G (i.e., the work table 63).

It is noted that the transport destination G is not limited to a position in the same area I. When a position in another area (also referred to as “other area”) other than the area I is designated as the transport destination G, for example, the robot controller 1 firstly moves the robot 5 to the other area after causing the robot 5 to hold the target object in the area I. Thereafter, the robot controller 1 formulates the operation plan for causing the robot 5 to place the target object in the designated transport destination G in the other area. Such an operation of the robot 5 can be realized by generating (i.e., by repeating the first operation plan and the second operation plan alternately) operation sequences, after the completion of operations based on the second operation plan to place the target object on the robot 5, for causing the robot 5 to arrive at the other area based on the first operation plan and then place the target object on the transport destination based on the second operation plan.

In this case, the route setting unit 30 firstly sets the reference point, in the area I that is a designated area, at which the robot 5 should arrive. In this case, for example, the route setting unit 30 sets the reference point to a position, in the area I, which is the closest position (or the fastest reachable position by the robot 5) to the robot 5 among positions which are a predetermined distance away from the position of the target object (here, the target object B) closer to the robot 5. The predetermined distance described above is set, for example, to a value that is the sum of the reach range distance (or a multiple thereof) of the robot 5 (specifically, the manipulator 52) and the movement error of the robot 5. The above-described movement error of the robot 5 is, specifically, the sum of the error of the self position estimation accuracy acquired in the process of performing the self-position estimation and the error regarding the movement control of the robot 5. The error information regarding these errors may be previously stored in the storage device 4, for example. The error information obtained at the time of the self position estimation may be used as the error information regarding the self position estimation.

In this way, the route setting unit 30 determines the reference point based on the position of the target object, the movement error of the robot 5, and the reach range of the robot 5. Thus, the route setting unit 30 can determine the reference point to be an appropriate position as the operation start point of the robot 5 in formulating the second operation plan.

Here, the necessity of setting an appropriate reference point will be supplemented. Generally, if the reference point is too close to the target object 6, it is impossible to calculate the optimum second operation sequence Sr2 which defines the operations of the robot body 50 and the operations of the manipulator 52, respectively. On the other hand, if the reference point is too far from the target object 6, the computational complexity for calculating the second operation sequence Sr2 increases. In view of the above, the route setting unit 30 determines a reference point such that movement of the robot main body 50 is reduced as much as possible in the second operation plan, on the basis of the position of the target object, the movement error of the robot 5, and the reach range of the robot 5. Thus, it is possible to suitably formulate the operation plan regarding the movement of the robot 5 and the manipulator 52 while preventing the above-described increase in the calculation amount.

In addition, the route setting unit 30 determines such a robot route that the robot 5 can reach the reference point at the shortest time without colliding with an obstacle (in this case, other work tables 54A to 54E and the like) recorded in the map information 17. In this case, the route setting unit 30 may determine the robot route based on an arbitrary route search technique.

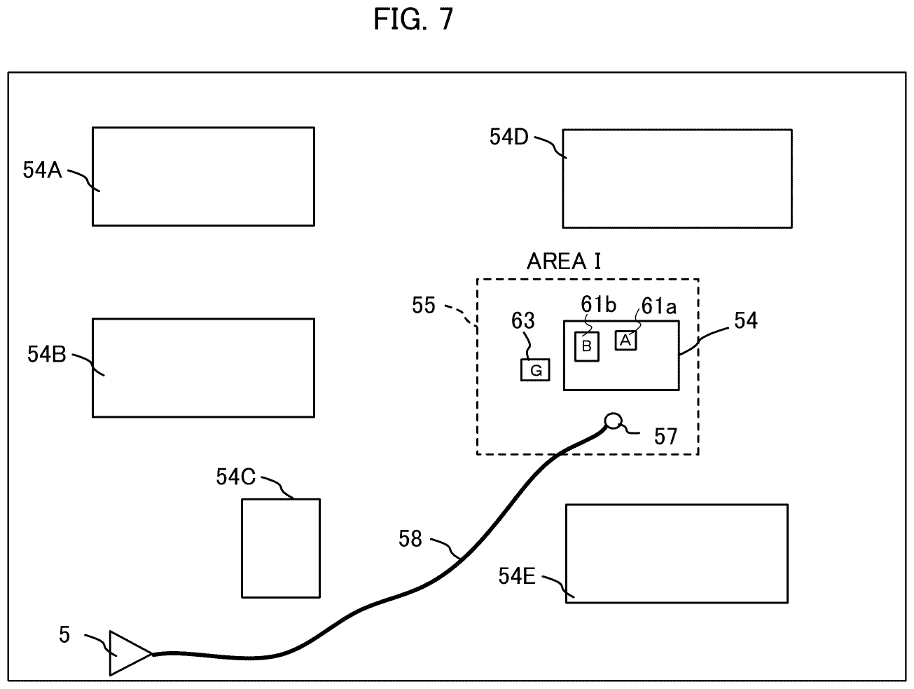

FIG. 7 is a diagram illustrating a reference point and a robot route set by the route setting unit 30. In FIG. 7, the point 57 represents a reference point, and the route line 58 represents the robot route. The route setting unit 30 determines the reference point and the robot route shown in FIG. 7 and supplies the route information Irt indicating the determined robot route to the subtask sequence generation unit 36. Thereafter, the subtask sequence generation unit 36 generates the first operation sequence Sr1 based on the route information Irt. Then, the robot control unit 17 controls the robot 5 to move along the robot route by supplying a control signal S3 based on the first operation sequence Sr1 to the robot 5.
(5-3) Abstract State Setting Unit

Next, a description will be given of the process executed by the abstract state setting unit 31. If the abstract state setting unit 31 determines that the operation of the robot 5 based on the first operation sequence Sr1 has been completed (that is, the robot 5 has reached the reference point), the abstract state setting unit 31 performs the setting of the abstract state setting space, the generation of the recognition result Im, and the setting of the abstract states. In this case, for example, if the abstract state setting unit 31 receives the completion notice of the first operation sequence Sr1 from the robot 5 or the robot control unit 17, the abstract state setting unit 31 determines that the robot 5 has reached the reference point. In another example, the abstract state setting unit 31 may determine whether or not the robot 5 has reached the reference point, based on a sensor signal S4 such as camera images.

In generating the recognition result Im, the abstract state setting unit 31 refers to the object model information 16 and analyzes the sensor signal S4 through a technique (such as an image processing technique, an image recognition technique, a speech recognition technique, and a RFID (Radio Frequency Identifier) related technique) for recognizing the environment of the abstract state setting space. Thereby, the abstract state setting unit 31 generates information regarding the type, the position, and the posture of each object in the abstract state setting space as the recognition result Im. Examples of the objects in the abstract state setting space include the robot 5, target objects to be handled by the robot 5 such as a tool and a part, an object such as a robot 5, a tool or a part handled by the robot 5, an obstacle, and another working body (a person or any other object performing a work other than the robot 5).

Next, the abstract state setting unit 31 sets the abstract states in the abstract state setting space based on the recognition result Im and the abstract state specification information I1 acquired from the application information storage unit 41. In this case, first, the abstract state setting unit 31 refers to the abstract state specification information I1 and recognizes the abstract states to be set in the abstract state setting space. The abstract states to be set in the abstract state setting space vary depending on the type of the objective task. Therefore, if the abstract states to be set for each type of objective task is specified in the abstract state specification information I1, the abstract state setting unit 31 refers to the abstract state specification information I1 corresponding to the objective task to be currently executed, and recognizes the abstract states to be set.

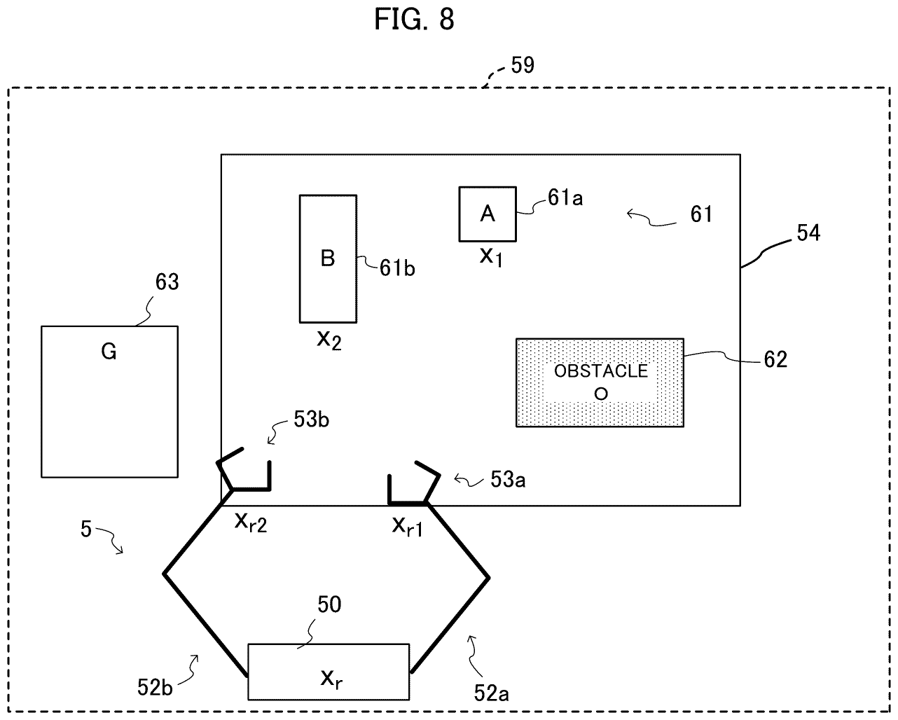

FIG. 8 illustrates a bird's-eye view of the abstract state setting space 59 set by the abstract state setting unit 31. In the abstract state setting space 59 shown in FIG. 8, there are a robot 5 in which two manipulators 52a, 52b are attached to a robot main body 50, a work table 54 on which there are two target objects 61 (target objects A and B) and an obstacle 62, and a second work table 63 (transport destination G) which is a transport destination of the target objects 61.

In this case, first, the abstract state setting unit 31 recognizes the existence range of the work table 54, the states of the target object A and the target object B, the existence range of the obstacle 62, the state of the robot 5, the existence range of the transport destination G, and the like. Then, for example, the abstract state setting unit 31 expresses the position of each recognized element by using a coordinate system with respect to the abstract state setting space 59 set as a reference. For example, the reference point described above, which is the start point in the second operation plan, may be used as a reference to determine the coordinate system with respect to the abstract state setting space 59.

Here, the abstract state setting unit 31 recognizes the position vectors “x₁” and “x₂” that are center position vectors of the target object A and the target object B as the positions of the target object A and the target object B. The abstract state setting unit 31 recognizes the position vector “xᵣ₁” of the robot hand 53a holding a target object and the position vector “xᵣ₂” of the robot hand 53b as the positions of the manipulator 52a and the manipulator 52b, respectively. Furthermore, the abstract state setting unit 31 recognizes the position vector “xᵣ” of the robot main body 50 as the position of the robot main body 50. In this case, the position vector xᵣ₁ and the position vector xᵣ₂ may be relative vectors with reference to the position vector xᵣ of the robot main body 50. In this case, the position of the manipulator 52a in the coordinate system of the abstract state setting space 59 is represented by “xᵣ+xᵣ₁”, and the position of the manipulator 52b in the coordinate system of the abstract state setting space 59 is represented by the position vector “xᵣ+xᵣ₂”.

The abstract state setting unit 31 recognizes the postures of the target object A and the target object B, the existence range of the obstacle 62, the existence range of the transport destination G, and the like in the same way. For example, when the obstacle 62 is regarded as a rectangular parallelepiped and the transport destination G is regarded as a rectangular parallelepiped, the abstract state setting unit 31 recognizes the position vector of each vertex of the obstacle 62 and the transport destination G.

The abstract state set by the abstract state setting unit 31 is represented by, for example, the following abstract state vector “z”.

$${z}^{T} ( {x}_{r} , {x}_{r 1} , {x}_{r 2} , {x}_{1} , {x}_{2} , … )$$

This abstract state vector includes not only the abstract states of the manipulators 52a and 52b but also the abstract state of the robot body 50. Therefore, the abstract state vector z is also referred to as the augmented state vector. Through the optimization process by using the abstract state vector z, the control input generation unit 35 suitably generates the trajectory data of the manipulators 52a and 52b and the robot main body 50 for each time step.

The abstract state setting unit 31 determines the abstract states to be defined in the objective task by referring to the abstract state specification information I1. In this case, the abstract state setting unit 31 defines propositions indicating the abstract states based on the recognition result Im (e.g., the number of objects for each type) regarding each object in the abstract state setting space and the abstract state specification information I1.

In the example shown in FIG. 8, the abstract state setting unit 31 assigns the identification labels “1” and “2” to the target object A and the target object B specified by the recognition result Im, respectively. The abstract state setting unit 31 defines the proposition “gᵢ” that the target object “i” (i=1 or 2) is present in the transport destination G which is the target point to be finally transferred. Further, the abstract state setting unit 31 assigns an identification label “O” to the obstacle 62, and then defines the proposition “oᵢ” that the target object i interferes with the obstacle O. Furthermore, the abstract state setting unit 31 defines a proposition “h” that the manipulators 52 interfere with each other. The proposition “h” may also include a condition that the manipulator 52 and the robot main body 50 do not interfere with each other. Besides, the abstract state setting unit 31 may further define a proposition “vᵢ” that the target object “i” is present on the work table 54 (the table on which the target object and obstacles are present in the initial state), a proposition “wᵢ” that the target object exists in the non-work area other than the work table 54 and the transport destination G. The non-work area is, for example, an area (such as a floor surface) in which a target object is present when the target object falls from the work table 54.

Thus, the abstract state setting unit 31 recognizes the abstract states to be defined by referring to the abstract state specification information I1, and then defines the propositions (gᵢ, oᵢ, h, and the like in the above-described example) representing the abstract states, in accordance with the number of the target objects 61, the number of the manipulators 52, the number of obstacles 62, the number of the robots 5 (manipulators 52) and the like, respectively. The abstract state setting unit 31 supplies information indicating the propositions representing the abstract states to the target logical formula generation unit 32 as the abstract state setting information IS.
(5-4) Target Logical Formula Generation Unit

First, the target logical formula generation unit 32 converts the objective task indicated by the task specification information Ia into a logical formula in the form of a temporal logic.

For example, in the example of FIG. 8, it is herein assumed that the objective task “the target object (i=2) finally exists in the transport destination G” is given. In this case, the target logical formula generation unit 32 generates the logical formula “⋄g₂” which represents the objective task by using the operator “⋄” corresponding to “eventually” of the linear logical formula (LTL: Linear Temporal Logic) and the proposition “gᵢ” defined by the abstract state setting unit 31. The target logical formula generation unit 32 may express the logical formula by using any operators according to the temporal logic other than the operator “⋄” such as logical AND “∧”, logical OR “∨”, negative “¬”, logical implication “⇒”, always “□”, next “∘”, and until “U”. The logical formula may be expressed by any temporal logic other than linear temporal logic such as MTL (Metric Temporal Logic) and STL (Signal Temporal Logic).

The task specification information Ia may be information specifying the objective task in a natural language. There are various techniques for converting a task expressed in a natural language into logical formulas.

Next, the target logical formula generation unit 32 generates the target logical formula Ltag by adding the constraint conditions indicated by the constraint condition information 12 to the logical formula indicating the objective task.

For example, provided that two constraint conditions “a manipulator 52 does not interfere with another manipulator 52” and “the target object i does not interfere with the obstacle O” for pick-and-place shown in FIG. 8 are included in the constraint condition information 12, the target logical formula generation unit 32 converts these constraint conditions into the logical formula. Specifically, the target logical formula generation unit 32 converts the above-described two constraint conditions into the following logical formulas, respectively, using the proposition “oᵢ” and the proposition “h” defined by the abstract state setting unit 31 in the case shown in FIG. 8.

$$□ ¬ h$$

$$⋀ , □ ¬ ◦ ,$$

Therefore, in this case, the target logical formula generation unit 32 generates the following target logical formula Ltag obtained by adding the logical formulas of these constraint conditions to the logical formula “⋄g₂” corresponding to the objective task “the target object (i=2) finally exists in the transport destination G”.

$$( ◇ {g}_{2} ) ⋀ ( □ ¬ h ) ⋀ ( ⋀ , □ ¬ {◦}_{i} )$$

In practice, the constraint conditions corresponding to the pick-and-place is not limited to the above-described two constraint conditions and there are other constraint conditions such as “a manipulator 52 does not interfere with the obstacle O”, “plural manipulators 52 do not grasp the same target object”, “target objects does not contact with each other”. Such constraint conditions are also stored in the constraint condition information 12 and are reflected in the target logical formula Ltag.
(5-5) Time Step Logical Formula Generation Unit

The time step logical formula generation unit 33 determines the number of time steps (also referred to as the “target time step number”) needed to complete the objective task, and determines possible combinations of propositions representing the states at every time step such that the target logical formula Ltag is satisfied with the target time step number. Since the combinations are normally plural, the time step logical formula generation unit 33 generates the time step logical formula Lts that is a logical formula obtained by combining these combinations by logical OR. Each of the combinations described above is a candidate of a logical formula representing a sequence of operations to be instructed to the robot 5, and therefore it is hereinafter also referred to as “candidate φ”.

Here, a description will be given of a specific example of the process executed by the time step logical formula generation unit 33 in the case where the objective task “the target object (i=2) finally exists in the transport destination G” exemplified in FIG. 8 is set.

In this instance, the following target logical formula Ltag is supplied from the target logical formula generation unit 32 to the time step logical formula generation unit 33.

$$( ◇ {g}_{2} ) ⋀ ( □ ¬ h ) ⋀ ( ⋀ , □ ¬ {◦}_{i} )$$

In this case, the time-step logical formula generation unit 33 uses the proposition “g_{i,k}” that is the extended proposition “gᵢ” to include the concept of time steps. Here, the proposition “g_{i,k}” is the proposition “the target object i exists in the transport destination G at the time step k”. Here, when the target time step number is set to “3”, the target logical formula Ltag is rewritten as follows.

$$( {◇g}_{2 , 3} ) ⋀ ( {⋀}_{k = 1 , 2 , 3} □ ¬ {h}_{k} ) ⋀ ( {⋀}_{i , k = 1 , 2 , 3} □ ¬ {◦}_{i , k} )$$

⋄g_{2,3} can be rewritten as shown in the following expression.

$$\begin{matrix}◇ {g}_{2 , 3} = ( ¬ {g}_{2 , 1} ⋀ ¬ {g}_{2 , 2} ⋀ {g}_{2 , 3} ) ⋁ ( ¬ {g}_{2 , 1} ⋀ {g}_{2 , 2} ⋀ {g}_{2 , 3} ) \\ ⋁ ( {g}_{2 , 1} ⋀ ¬ {g}_{2 , 2} ⋀ {g}_{2 , 3} ) ⋁ ( {g}_{2 , 1} ⋀ {g}_{2 , 2} ⋀ {g}_{2 , 3} )\end{matrix} \qquad [ Formula 1 ]$$

The target logical formula Ltag described above is represented by logical OR (φ₁∨φ₂ ∨φ₃∨φ₄) of four candidates “φ₁” to “φ₄” as shown in below.

$${ϕ}_{1} = ( ¬ {g}_{2 , 1} ⋀ ¬ {g}_{2 , 2} ⋀ {g}_{2 , 3} ) ⋀ ( {⋀}_{k = 1 , 2 , 3} □ ¬ {h}_{k} ) ⋀ ( {⋀}_{i , k = 1 , 2 , 3} □ ¬ {o}_{i , k} ) \qquad [ Formula 2 ]$$

$${ϕ}_{2} = ( ¬ {g}_{2 , 1} ⋀ ¬ {g}_{2 , 2} ⋀ {g}_{2 , 3} ) ⋀ ( {⋀}_{k = 1 , 2 , 3} □ ¬ {h}_{k} ) ⋀ ( {⋀}_{i , k = 1 , 2 , 3} □ ¬ {o}_{i , k} )$$

$${ϕ}_{3} = ( {g}_{2 , 1} ⋀ ¬ {g}_{2 , 2} ⋀ {g}_{2 , 3} ) ⋀ ( {⋀}_{k = 1 , 2 , 3} □ ¬ {h}_{k} ) ⋀ ( {⋀}_{i , k = 1 , 2 , 3} □ ¬ {o}_{i , k} )$$

$${ϕ}_{4} = ( {g}_{2 , 1} ⋀ {g}_{2 , 2} ⋀ {g}_{2 , 3} ) ⋀ ( {⋀}_{k = 1 , 2 , 3} □ ¬ {h}_{k} ) ⋀ ( {⋀}_{i , k = 1 , 2 , 3} □ ¬ {o}_{i , k} )$$

Therefore, the time step logical formula generation unit 33 determines the time step logical formula Lts to be the logical OR of the four candidates φ₁ to φ₄. In this case, the time step logical formula Lts is true if at least one of the four candidates φ₁ to φ₄ is true.

Next, a supplementary description will be given of a method of setting the target time step number.

For example, the time step logical formula generation unit 33 determines the target time step number based on the prospective work time specified by the input signal S1 supplied from the instruction device 2. In this case, the time step logical formula generation unit 33 calculates the target time step number based on the prospective work time described above and the information on the time width per time step stored in the memory 12 or the storage device 4. In another example, the time step logical formula generation unit 33 stores in advance in the memory 12 or the storage device 4 information in which a suitable target time step number is associated with each type of objective task, and determines the target time step number in accordance with the type of objective task to be executed by referring to the information.

In some embodiments, the time step logical formula generation unit 33 sets the target time step number to a predetermined initial value. Then, the time step logical formula generation unit 33 gradually increases the target time step number until the time step logical formula Lts which enables the control input generation unit 35 to determine the control input is generated. In this case, if the control input generation unit 35 ends up not being able to derive the optimal solution in the optimization processing with the set target time step number, the time step logical formula generation unit 33 adds a predetermined number (1 or more integers) to the target time step number.

In this case, the time step logical formula generation unit 33 may set the initial value of the target time step number to a value smaller than the number of time steps corresponding to the work time of the objective task expected by the user. Thus, the time step logical formula generation unit 33 suitably suppresses setting the target time step number to an unnecessarily large number.
(5-6) Abstract Model Generation Unit

The abstract model generation unit 34 generates the abstract model Σ based on the abstract model information I5 and the recognition result Im. Here, in the abstract model information I5, information required to generate the abstract model Σ is recorded for each type of objective task. For example, when the objective task is a pick-and-place, a general-purpose abstract model is recorded in the abstract model information I5, wherein the position or the number of target objects, the position of the area where the target objects are to be placed, the number of robots 5 (or the number of the manipulators 52), and the like are not specified in the general-purpose abstract model. The abstract model information I5 additionally includes an abstract model regarding the movement of the robot main body 50. The abstract model generation unit 34 generates the abstract model Σ by reflecting the recognition result Im in the general-purpose abstract model which includes the dynamics (more specifically, the dynamics of the robot main body 50 and the dynamics of the manipulator 52) of the robot 5 and which is recorded in the abstract model information I5. Thereby, the abstract model Σ is a model in which the states of objects existing in the abstract state setting space and the dynamics of the robot 5 are abstractly expressed. In the case of pick-and-place, the states of the objects existing in the abstract state setting space indicate the position and the number of the target objects, the position of the area where the target object are to be placed, the number of robots 5, and the like.

When there are one or more other working bodies, information on the abstracted dynamics of the other working bodies may be included in the abstract model information I5. In this case, the abstract model Σ is a model in which the states of the objects existing in the abstract state setting space, the dynamics of the robot 5, and the dynamics of the other working bodies are abstractly expressed.

Here, during the work of the objective task by the robot 5, the dynamics in the abstract state setting space is frequently switched. For example, in the case of pick-and-place, while the manipulator 52 is gripping the target object i, the target object i can be moved. However, if the manipulator 52 is not gripping the target object i, the target object i cannot be moved.

In view of the above, in the present example embodiment, in the case of pick-and-place, the operation of grasping the target object i is abstractly expressed by the logical variable “δᵢ”. In this case, for example, the abstract model generation unit 34 can define the abstract model Σ to be set for the abstract state setting space shown in FIG. 8 as the following equation (1).

$$\begin{matrix}[ Formula 3 ] & \\ {\text{?} )}_{\text{?}} = I ( \begin{matrix}{x}_{r} \\ {x}_{r 1} \\ {x}_{r 2} \\ {x}_{1} \\ {x}_{2}\end{matrix} ) + ( \begin{matrix}I & 0 & 0 \\ I & I & 0 \\ I & 0 & I \\ {δ}_{12 , 1} I & {δ}_{1 , 1} I & {δ}_{2 , 1} I \\ {δ}_{12 , 2} I & {δ}_{1 , 2} I & {δ}_{2 , 2} I\end{matrix} ) ( \begin{matrix}1 \\ 1 \\ 1\end{matrix} \text{?} & ( 1 )\end{matrix}$$

$$\text{?} \text{indicates text missing or illegible when filed}$$

Here, “u₀” indicates a control input of controlling the robot main body 50, “u₁” indicates a control input of controlling the manipulator 52a, and “u₂” indicates a control input of controlling the manipulator 52b. “I” indicates a unit matrix and “0” indicates zero (null) matrix. It is noted that the control input is herein assumed to be a speed as an example but it may be an acceleration. Further, “δ_{j,i}” is a logical variable that is set to “1” when the manipulator j (“j=1” indicates the manipulator 52a and “j=2” indicates the manipulator 52b) grasps the target object i and that is set to “0” in other cases. “δ_{12,i}” is a logical variable that is set to “1” the target object i moves along with the movement of the robot main body 50 while the manipulator 1 or 2 grasps the target object i, and that is set to “0” in other cases. Each of “xᵣ₁” and “xᵣ₂” indicates the position vector of the manipulator j (j=1, 2), and each of “x₁” and “x₂” indicates the position vector of the target object i (i=1, 2). The coordinates xᵣ₁ and xᵣ₂ of the manipulators 52 and the coordinates x₁ and x₂ are expressed in the coordinate system with respect to the abstract state setting space. Therefore, if the robot main body 50 moves (due to the “u₀”), the manipulator 52 and the target objects i grasped by the manipulator 5 also move accordingly.

Further, “h (x)” is a variable to be “h (x)>=0” when the robot hand (i.e., the position vector xᵣ₁ or xᵣ₂ of the manipulator 52) exists in the vicinity of a target object to such an extent that it can grasp the target object, and satisfies the following relationship with the logical variable

$$δ = 1 ⇔ h ( x ) \geq 0$$

In the above expression, when the robot hand exists in the vicinity of a target object to such an extent that the target object can be grasped, it is considered that the robot hand grasps the target object, and the logical variable δ is set to 1.

Here, the expression (1) is a difference equation showing the relationship between the states of the objects at the time step k and the states of the objects at the time step k+1. Then, in the above expression (1), the state of grasping is represented by a logical variable that is a discrete value, and the movement of the target object is represented by a continuous value. Accordingly, the expression (1) shows a hybrid system.

The expression (1) considers not the detailed dynamics of the entire robot 5 but only the dynamics of the robot hand, which is the hand of the robot 5 that actually grasps a target object. Thus, it is possible to suitably reduce the calculation amount of the optimization process by the control input generation unit 35.

Further, the abstract model information I5 includes: information for deriving the difference equation indicated by the expression (1) from the recognition result Im; and the logical variable corresponding to the operation (the operation of grasping a target object i in the case of pick-and-place) causing the dynamics to switch. Thus, even when there is a variation in the position and the number of the target objects, the area (the transport destination G in FIG. 8) where the target objects are to be placed and the number of the robots 5 and the like, the abstract model generation unit 34 can determine the abstract model Σ in accordance with the environment of the target abstract state setting space based on the abstract model information I5 and the recognition result Im.

It is noted that, in place of the model shown in the expression (1), the abstract model generation unit 34 may generate any other hybrid system model such as mixed logical dynamical (MLD) system and a combination of Petri nets and automaton.
(5-7) Control Input Generation Unit

The control input generation unit 35 determines the optimal control input of the robot 5 with respect to each time step based on the time step logical formula Lts supplied from the time step logical formula generation unit 33 and the abstract model Σ supplied from the abstract model generation unit 34. In this case, the control input generation unit 35 defines an evaluation function for the objective task and solves the optimization problem of minimizing the evaluation function while setting the abstract model Σ and the time step logical formula Lts as constraint conditions. For example, the evaluation function is predetermined for each type of the objective task and stored in the memory 12 or the storage device 4.

For example, the control input generation unit 35 determines the evaluation function such that the magnitude of the control input “uₖ” and the distance “dₖ” between a target object to be carried and the goal point of the target object are minimized (i.e., the energy spent by the robot 5 is minimized). The distance dₖ described above corresponds to the distance between the target object 2 and the transport destination G when the objective task is “the target object (i=2) finally exists in the transport destination G.”

For example, the control input generation unit 35 determines the evaluation function to be the sum of the square of the distance dₖ and the square of the control input uₖ in all time steps. Then, the control input generation unit 35 solves the constrained mixed integer optimization problem shown in the following expression (2) while setting the abstract model Σ and the time-step logical formula Lts (that is, the logical OR of the candidates φᵢ) as the constraint conditions.

$$\begin{matrix}[ Formula 4 ] & \\ {min}_{u} ( {\sum }_{k = 0}^{T} ( {‖ {d}_{k} ‖}_{2}^{2} + {‖ {u}_{k} ‖}_{2}^{2} ) ) & ( 2 )\end{matrix}$$

$$s . t . \sum$$

$$⋁ {ϕ}_{i}$$

Here, “T” is the number of time steps to be set in the optimization and it may be a target time step number or may be a predetermined number smaller than the target time step number as described later. In some embodiments, the control input generation unit 35 approximates the logical variable to a continuous value (i.e., solve a continuous relaxation problem). Thereby, the control input generation unit 35 can suitably reduce the calculation amount. When STL is adopted instead of linear temporal logic (LTL), it can be described as a nonlinear optimization problem.

Further, if the target time step number is large (e.g., larger than a predetermined threshold value), the control input generation unit 35 may set the time step number T in the expression (2) used for optimization to a value (e.g., the threshold value described above) smaller than the target time step number. In this case, the control input generation unit 35 sequentially determines the control input uₖ by solving the optimization problem based on the expression (2), for example, every time a predetermined number of time steps elapses.

In some embodiments, the control input generation unit 35 may solve the optimization problem based on the expression (2) for each predetermined event corresponding to the intermediate state for the accomplishment state of the objective task and determine the control input uₖ to be used. In this case, the control input generation unit 35 determines the time step number T in the expression (2) to be the number of time steps up to the next event occurrence. The event described above is, for example, an event in which the dynamics switches in the abstract state setting space. For example, when pick-and-place is the objective task, examples of the event include “the robot 5 grasps the target object” and “the robot 5 finishes carrying one of the target objects to the destination (goal) point.” For example, the event is predetermined for each type of the objective task, and information indicative of one or more events for each type of the objective task is stored in the storage device 4.

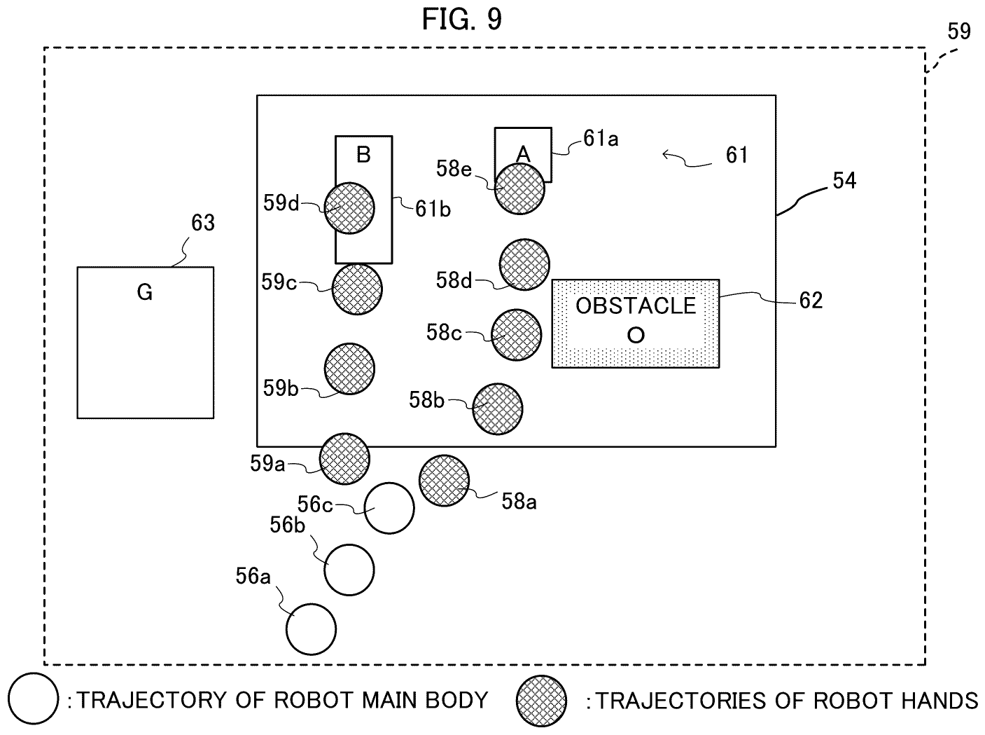

FIG. 9 is a diagram schematically illustrating the trajectories of the robot main body 50 and the manipulators 52a and 52b based on the control input information Icn generated by the control input generation unit 35. In FIG. 9, the trajectories of the manipulators 52a and 52b by the time the manipulator 52a grasps the object A and the manipulator 52b grasps the object B are shown. The points 56a to 56c indicate the predicted positions (i.e., the transitions of xᵣ) of the robot main body 50 for respective time steps, points 58a to 58e indicate the predicted positions (i.e., the transitions of xᵣ₁) of the manipulator 52a for respective time steps, and the points 59a to 59d indicate the predicted positions (i.e., the transitions of xᵣ₂) of the manipulator 52b for respective time steps. It is noted that the positions of the manipulators 52a and 52b are abstractly represented by the positions of the robot hands 53a and 53b.

Here, the time period of the time steps corresponding to the points 56a to 56c, the time period of the time steps corresponding to the points 58a to 58e, and the time period of the time steps corresponding to the points 59a to 59d may overlap with one another or may not overlap with one another. The presence or absence of the overlapping depends on the setting of the priority (such as the priority of safety and the priority of takt time) in the execution of the objective task set by the user. The setting of the priority is explained in detail in the section “(6) Determination of Constraint Conditions and Evaluation Function According to Setting of Priority”.

Based on the above-described optimization process, the control input generation unit 35 determines the abstract state vector z and the control input for each time step. Thereby, it is possible to specify the respective trajectories of the robot main body 50 and the manipulators 52a and 52b as shown in FIG. 9.
(5-8) Subtask Sequence Generation Unit

The subtask sequence generation unit 36 generates the operation sequence Sr based on the control input information Icn supplied from the control input generation unit 35 and the subtask information 14 stored in the application information storage unit 41. In this case, by referring to the subtask information 14, the subtask sequence generation unit 36 recognizes subtasks that the robot 5 can accept and converts the control input of every time step indicated by the control input information Icn into subtasks.

For example, in the subtask information 14, there are defined functions representing three subtasks, movement (MOVING) of the robot main body 50, the movement (REACHING) of the robot hand and the grasping (GRASPING) by the robot hand, as subtasks that can be accepted by the robot 5 when the objective task is pick-and-place. In this instance, the function “Move” representing the above-mentioned MOVING is a function that uses the following three arguments (parameter): the initial state of the robot 5 prior to the execution of the function; the route indicated by the route information Irt (or the final state of the robot 5 after the execution of the function); and the time required for the execution of the function (or the moving speed of the robot main body 50). The function “Reach” representing the above-mentioned REACHING is, for example, a function that uses the following three arguments: the initial state of the robot 5 before the function is executed; the final state of the robot 5 after the function is executed; and the time to be required for executing the function. In addition, the function “Grasp” representing the above-mentioned GRASPING is, for example, a function that uses the following these arguments: the state of the robot 5 before the function is executed; the state of the target object to be grasped before the function is executed; and the logical variable δ. Here, the function “Grasp” indicates performing a grasping operation when the logical variable δ is “1”, and indicates performing a releasing operation when the logical variable δ is “0”. In this case, the subtask sequence generation unit 36 determines the function “Reach” based on the trajectories of the manipulators 52 determined by the control input for each time step indicated by the control input information Icn, and determines the function “Grasp” based on the transition of the logical variable δ for each time step indicated by the control input information Icn. The subtask sequence generation unit 36 determines the function “Move” based on the trajectory of the robot main body 50 identified by the route information Irt or the control input for each time step indicated by the control input information Icn. Here, the arguments of the function “Move” for moving the robot main body 50 and the parameters for adjusting the property may be different between the process of moving the robot main body 50 to the reference point based on the route information Irt and the process of moving the robot main body 50 at the same time as the movement (reaching) of the manipulator 52 and/or grasping by the manipulator 52 based on the control input information Icn after the arrival at the reference point. Namely, the format (argument, parameter, and the like) of the function “Move” used in generating the first operation sequence Sr1 may be different from the format of the function “Move” used in generating the second operation sequence Sr2.

If the route information Irt is supplied from the route setting unit 30, the subtask sequence generation unit 36 generates the first operation sequence Sr1 by using the function “Move” and supplies the first operation sequence Sr1 to the robot control unit 17. If the control input information Icn is supplied from the control input generation unit 35, the subtask sequence generation unit 36 generates the second operation sequence Sr2 by using the function “Move” and the function “Reach” and the function “Grasp” and supplies the second operation sequence Sr2 to the robot control unit 17.

For example, when “Finally the target object (i=2) exists in the transport destination G” is given as the objective task, the subtask sequence generation unit 36 generates a second operation sequence Sr2 including a sequence of the function “Reach”, the function “Grasp”, the function “Reach”, and the function “Grasp” for the manipulator 52 closest to the target object (i=2) in formulating the second operation plan. In this instance, the manipulator 52 closest to the target object (i=2) moves to the position of the target object (i=2) by the function “Reach” at the first time, grasps the target object (i=2) by the function “Grasp” at the first time, moves to the transport destination G by the function “Reach” at the second time, and places the target object (i=2) on the transport destination G by the function “Grasp” at the second time.
(6) Determination of Constraint Condition and Evaluation Function According to Setting of Priority

The robot controller 1 recognizes the setting of the priority in executing the objective task specified by the user, based on the input signal S1 supplied from the instruction device 2, and determines the constraint conditions and the evaluation function according to the setting of the priority. Here, Examples of the priory to be set include “the priority of safety”, “the priority of work time length (the priority of takt time)”, and “the priority of power consumption”. In this case, information (also referred to as “priority correspondence information”) in which each possible priority that can be set is associated with at least one of the constraint conditions or the evaluation function to be used is stored in the application information storage unit 41 or the like, and the robot controller 1 determines the constraint conditions or/and the evaluation function to be used based on the priority correspondence information and the priority indicated by the task designation information Ia.

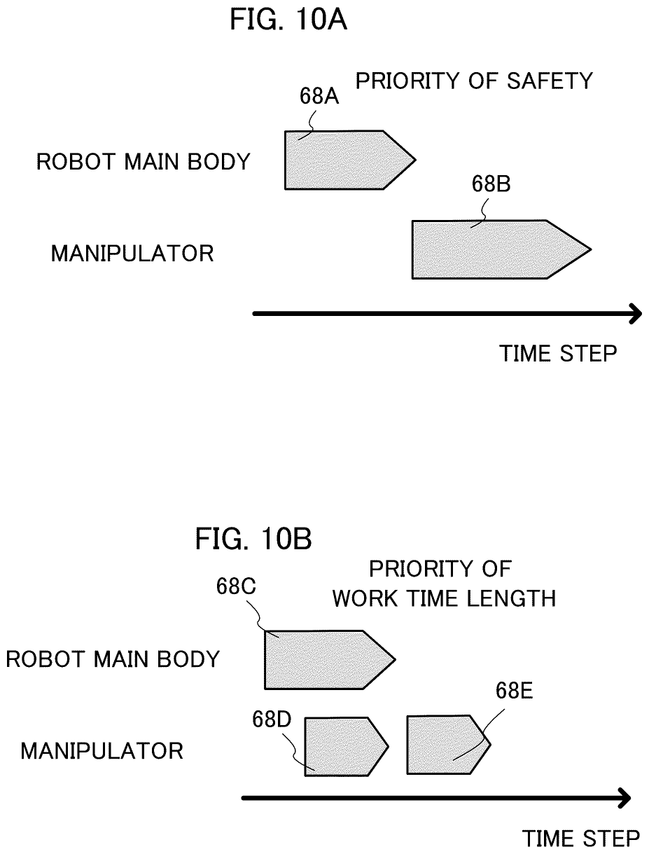

FIG. 10A illustrates the time steps corresponding to the execution period of the second operation sequence Sr2 with clear indication of a band 68A indicating the operation period of the robot main body 50 and a band 68B indicating the operation period of the manipulator 52 when the priority of safety is set.

If the priority of safety is set, the robot controller 1 determines that it is necessary to operate the robot main body 50 and the manipulator 52 exclusively on the time axis, and operates the manipulator 52 after the movement of the robot main body 50 is completed. In this instance, the target logical formula generation unit 32 of the robot controller 1 generates an expression of a constraint condition representing “do not operate the robot main body 50 and the manipulator 52 at the same time” and adds the generated expression of the constraint condition to the target logical formula Ltag. In another example, the control input generation unit 35 performs an optimization process by separately adding such a constraint condition that “a control input to the robot main body 50 and a control input to the manipulator 52 do not occur at the same time step”. Accordingly, the robot controller 1 can generate the second operation sequence Sr2 considering the priority of safety specified by the user.

FIG. 10B illustrates the time steps in the second operation sequence Sr2 with clear indication of a band 68C indicating the operation period of the robot main body 50 and a band 68D indicating the operation period of the manipulator 52 when the priority of work time length is set.

When the priority of work time length is set, the robot controller 1 generates the second operation sequence Sr2 to operate the robot main body 50 and the manipulator 52 to actively make an overlapping operation period on the time-axis. In this case, in some embodiments, the control input generation unit 35 sets such an evaluation function (e.g., min {T}) that includes at least a term contributing to the minimization of the time step number T, instead of the evaluation function shown in the equation (2). In other words, the control input generation unit 35 additionally sets the evaluation function to have a positive correlation (a negative correlation in the case of maximizing the evaluation function instead of the equation (2)) with the time step T, i.e., sets an additional term that becomes a penalty for the time step. Examples of the above-mentioned penalty term include the number of time steps taken to reach a a first target object. Thus, the control input generation unit 35 can generate a second operation sequence Sr2 to execute the operation of the robot main body 50 and the operation of the manipulator 52 in parallel while shortening the work time length as much as possible.

If the priority of power consumption is set, the control input generation unit 35 uses the evaluation function shown in the equation (2) as it is, for example. In another example, the control input generation unit 35 sets the weight for the term regarding uₖ in the evaluation function to be larger than the weight for the other term(s) (the term regarding dₖ herein). In still another example, the control input generation unit 35 may set an evaluation function representing the relation between the value of the control input u and the power consumption. In that case, the above-described relation differs depending on the robot, and therefore information representing the evaluation function to be set for each robot type may be stored in the storage device 4 as the application information. Thus, the robot controller 1 can formulate an operation plan in which power consumption is prioritized. For other priorities, similarly, the robot controller 1 recognizes the constraint conditions or/and evaluation function to be set based on the priority correspondence information and uses them in formulating the operation plan. Thereby, it is possible to formulate the operation plan considering the specified priority.

In this way, the control input generation unit 35 can determine the trajectory of the robot for each time step in consideration of the time constraint based on the priority specified by the user in addition to the spatial constraint.
(7) Receiving Input on Objective Task

Next, the process of receiving input relating to the objective task on the task designation screen image will be described. Hereinafter, each display example of the task designation screen image displayed by the instruction device 2 under the control of the output control unit 15 will be described with reference to FIGS. 11 and 12.

FIG. 11 illustrates an example of the first display of the task designation screen image for specifying an objective task. The output control unit 15 generates an output control signal S2, and then transmits the output control signal S2 to the instruction device 2 to thereby control the instruction device 2 to display the task designation screen image shown in FIG. 11. The task designation screen image shown in FIG. 11 mainly includes an area designation field 80, an object designation field 81, a priority designation field 82, an execution button 83, and a stop button 84.

The output control unit 15 receives, in the area designation field 80, an input for designating a designated area in which the robot 5 performs work. Here, a symbol (“A”, “B”, “C” and the like) is assigned to each area which is a candidate of the designated area, and the output control unit 15 receives an input for selecting a symbol (“B” in this case) of the area to be a designated area in the area designation field 80. The output control unit 15 may display a map or the like of the workspace representing the correspondence between each symbol and the area in a pop-up manner in a separate window.

The output control unit 15 receives an input for designating a transport destination (goal point) of target objects (workpieces) in the object designation field 81. Here, the target objects are classified according to the shape, and the output control unit 15 receives an input for designating a transport destination for each classified target object in the object designation field 81. In the example shown in FIG. 11, the output control unit 15 receives an input to transfer two cubic target objects to the “transport destination 2” and transfer three rectangular parallelepiped target objects to the “transport destination 1” and transfer one cylindrical target object to the “transport destination 1” and transfer one cylindrical target object to the “transport destination 2” in the object designation field 81.

The output control unit 15 receives an input for selecting a priority in the priority designation field 82. Here, a plurality of candidates to be set as the priority are listed in the priority designation field 82, and the output control unit 15 receives a selection of one candidate (here, “safety”) for the priority from among them.

When it is detected that the execution button 83 is selected, the output control unit 15 receives an input signal S1 indicating the contents designated in the area designation field 80, the object designation field 81, and the priority designation field 82 from the instruction device 2 and generates task designation information Ia based on the received input signal S1. If the output control unit 15 detects that the stop button 84 is selected, the output control unit 15 stops the formulation of the operation plan.

FIG. 12 illustrates a second display example of the task designation screen image for designating the objective task. The output control unit 15 generates the output control signal S2, and then transmits the output control signal S2 to the instruction device 2 to thereby control the instruction device 2 to display the task designation screen image shown in FIG. 12. The task designation screen image shown in FIG. 12 mainly includes an area designation field 80A, a target object designation field 81A, a transport destination mark display field 81B, a priority designation field 82A, an execution button 83A, and a stop button 84A.

The output control unit 15 displays the map of the workspace by referring to the map information 17 in the area designation field 80A. Here, the output control unit 15 divides the displayed workspace into a predetermined number of areas (in this case, six areas), and displays each divided area to be selectable as a designation area. Instead of displaying the map by using a CG (Computer Graphics) of the workspace based on the map information 17, the output control unit 15 may display, as the map, the actual image obtained by capturing the workspace.

The output control unit 15 displays, in the target object designation field 81A, the actual image or the CG image of the target object (workpiece) in the area designated in the area designation field 80A. In this instance, the output control unit 15 acquires the sensor signal S4 that is an image or the like generated by a camera that photographs the area designated in the area designation field 80A, and displays, in the object designation field 81A, the latest state of the target object in the designated area based on the acquired sensor signal S4. The output control unit 15 receives an input to attach a mark for designating a transport destination to a target object displayed in the object designation field 81A. The marks for designating transport destinations include, as shown in the transport destination mark display field 81B, the solid line marking corresponding to the “transport destination 1” and the dotted line marking he corresponds to the “transport destination 2”.

The output control unit 15 receives an input for selecting the priority in the priority designation field 82A. Here, a plurality of candidates to be set as the priority are listed in the priority matter designation field 82, and the output control unit 15 receives a selection of one candidate (here, “safety”) for the priority from among them.

Then, if the output control unit 15 detects that the execution button 83 is selected, the output control unit 15 receives an input signal S1 indicating the contents designated in the area designation field 80A, the object designation field 81A, and the priority designation field 82A from the instruction device 2 and generates task designation information Ia based on the received input signal S1. Thus, the output control unit 15 can suitably generate the task designation information Ia. The output control unit 15 stops the formulation of the operation plan, if the output control unit 15 detects that the stop button 84 is selected.

As described above, according to the task designation screen image shown in the first display example or the second display example, the output control unit 15 can receive the user input required to generate the task designation information Ia and suitably acquire the task designation information Ia.
(8) Processing Flow

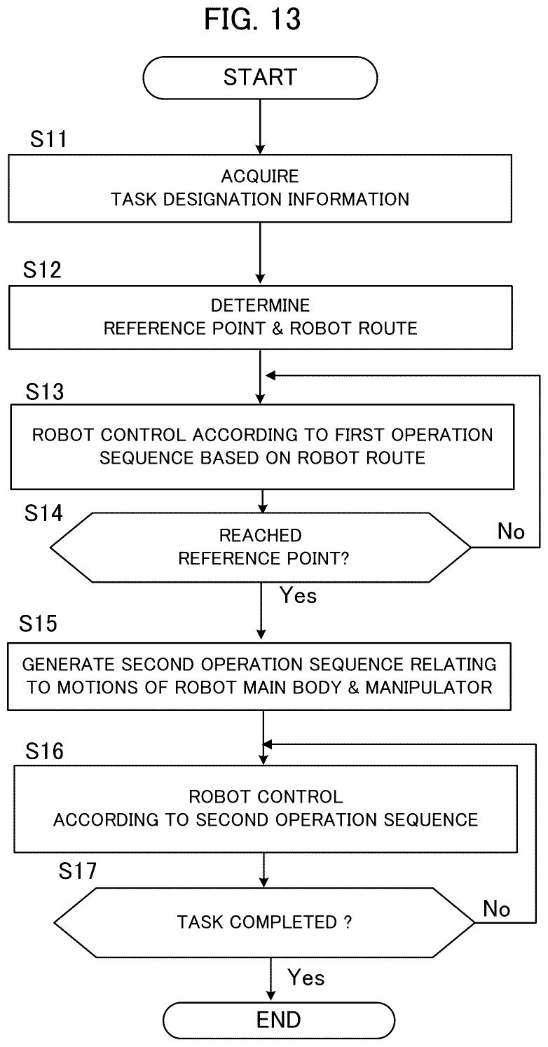

FIG. 13 is an example of a flowchart illustrating an outline of the process that is executed by the robot controller 1 in the first example embodiment.

First, the robot controller 1 acquires the task designation information Ia (step S11). In this instance, for example, the output control unit 15 displays a task designation screen image as shown in FIG. 11 or FIG. 12 on the instruction device 2 and receives the input signal S1 relating to designation of the objective task, thereby acquiring task designation information Ia. In another example, if the task designation information Ia is previously stored in the storage device 4 or the like, the robot controller 1 may acquire the task designation information Ia from the storage device 4 or the like.

Next, the robot controller 1 determines the reference point for the designated area indicated by the task designation information Ia acquired at step S1l, and determines the robot route which is a route to the determined reference point (step S12). In this instance, the route setting unit 30 sets the reference point on the basis of the position of the target object 6, the robot position, the reach range of the manipulator 52, or the like, and generates route information Irt indicating the robot route to reach the reference point.

Then, the robot controller 1 performs a robot control according to the first operation sequence Sr1 based on the robot route (step S13). In this instance, the robot control unit 17 supplies the robot 5 with control signals S3 in sequence based on the first operation sequence Sr1 for causing the robot 5 to move according to the robot route indicated by the route information Irt, and controls the robot 5 to operate according to the generated first operation sequence Sr1.

Then, the robot controller 1 determines whether or not the robot 5 has reached the reference point (step S14). Then, if it is determined that the robot 5 has not reached the reference point yet (step S14; No), the robot controller 1 continues the robot control based on the first operation sequence Sr1 at step S13.

On the other hand, if it is determined that the robot 5 has reached the reference point (step S14; Yes), the robot controller 1 generates the second operation sequence Sr2 relating to the movement of the robot main body 50 and the operation of the manipulators 52 (step S15). In this instance, the following processes are performed in sequence: the generation of the abstract state setting information IS by the abstract state setting unit 31; the generation of the target logical formula Ltag by the target logical formula generation unit 32; the generation of the time step logical formula Lts by the time step logical formula generation unit 33; the generation of the abstract model Σ by the abstract model generation unit 34; the generation of the control input information Icn by the control input generation unit 35; and the generation of the second operation sequence Sr2 by the subtask sequence generation unit 36.

Next, the robot controller 1 performs robot control by the second operation sequence Sr2 generated at step S15 (step S16). In this instance, the robot control unit 17 sequentially supplies the control signal Sr2 based on the second operation sequence S3 to the robot 5 and controls the robot 5 to operate according to the generated second operation sequence Sr2.

Then, the robot controller 1 determines whether or not the objective task has been completed (step S17). In this case, for example, the robot control unit 17 of the robot controller 1 determines that the objective task has been completed if the output of the control signal S3 to the robot 5 based on the second operation sequence Sr2 is completed (there has been no output). In another example, when the robot control unit 17 recognizes, based on the sensor signal S4, that the state of the object has reached the completion state, the robot control unit 17 determines that the objective task has been completed. If it is determined that the objective task has been completed (Step S17; Yes), the robot controller 1 ends the process of the flowchart. On the other hand, if it is determined that the objective task has not been completed (Step S17; No), the robot controller 1 continues the robot control based on the second operation sequence Sr2 at step S16.
(9) Modifications

Next, a description will be given of modifications of the first example embodiment. The following modifications may be applied in any combination.

### First Modification

The robot controller 1 may perform the generation of the first operation sequence Sr1 and the control of the robot 5 based on the first operation sequence Sr1 even in the situation where the states (including the state of the target object 6) within the designation area cannot be observed.

In this case, when receiving the task designation information Ia indicating the designated area, the robot controller 1 determines the reference point to be any point in the designated area indicated by the task designation information Ia and generates the first operation sequence Sr1 indicating the robot route to the reference point, thereby moving the robot 5 to the reference point. In this case, for example, the robot controller 1 sets, as the reference point, the point in the designated area where the robot 5 reaches with the shortest time, or, the point in the designated area closest to the starting position (present position) of the robot 5.

After the robot 5 reaches the reference point, the abstract state setting unit 31 of the robot controller 1 generates the recognition result Im relating to the objects in the designated area, on the basis of the sensor signal S4 generated by the sensor 7 provided in the robot 5. Thereafter, the robot controller 1 executes a process based on the above-described example embodiment including the generation of the second operation sequence Sr2 and the control of the robot 5 based on and the second operation sequence Sr2.

Thus, even when the robot controller 1 recognizes the states of the target objects or the like after reaching the reference point in the designated area, the robot controller 1 can suitably cause the robot 5 to execute the objective task.

### Second Modification

The block configuration of the operation planning unit 16 shown in FIG. 5 is an example, and various changes may be made thereto.

For example, information on the candidates p for the sequence of operations to be instructed to the robot 5 is stored in advance in the storage device 4, and based on the information, the operation planning unit 16 executes the optimization process to be executed by the control input generation unit 35. Thus, the operation planning unit 16 performs selection of the optimum candidate p and determination of the control input of the robot 5. In this instance, the operation planning unit 16 may not have a function corresponding to the abstract state setting unit 31, the target logical formula generation unit 32, and the time step logical formula generation unit 33 in generating the operation sequence Sr. Thus, information on the execution results from a part of the functional blocks in the operation sequence generation unit 16 shown in FIG. 5 may be stored in advance in the application information storage unit 41.

In another example, the application information includes design information such as a flowchart for designing the operation sequence Sr to complete the objective task in advance, and the operation planning unit 16 may generate the operation sequence Sr by referring to the design information. For example, JP2017-39170A discloses a specific example of executing a task based on a pre-designed task sequence.

### Third Modification

The route information Irt generated by the route setting unit 30 may be supplied to other process blocks instead of being supplied to the subtask sequence generation unit 36. For example, the control input generation unit 35 may receive the route information Irt, generate a control input for each time step to move along the robot route indicated by the route information Irt, and then provide the control input information Icn indicating the control input to the subtask sequence generation unit 36. In this case, the subtask sequence generation unit 36 generates the first operation sequence Sr1 based on the control input information Icn.

### Second Example Embodiment

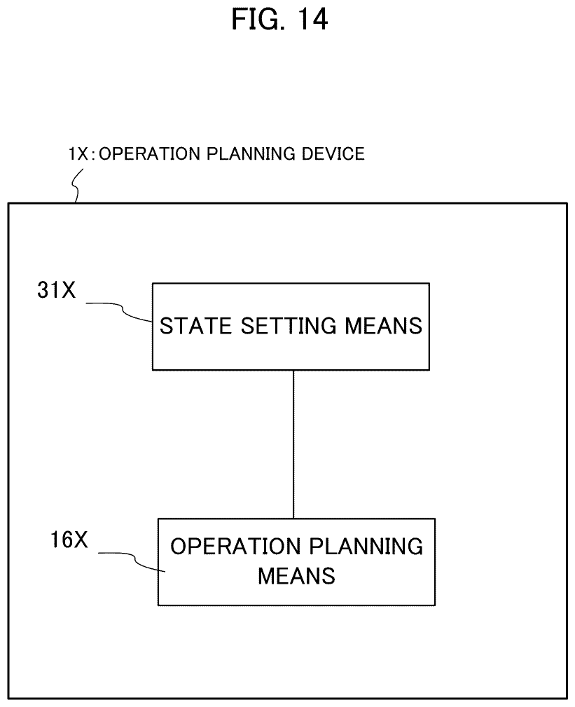

FIG. 14 illustrates a schematic configuration diagram of an operation planning device 1X in the second example embodiment. The operation planning device 1X mainly includes a state setting means 31X and an operation planning means 16X. The operation planning device 1X may be configured by a plurality of devices. Examples of the operation planning device 1X include the robot controller 1 in the first example embodiment.

The state setting means 31X is configured to set a state in a workspace where a mobile robot equipped with a manipulator handling a target object works. Examples of the state setting means 31X include an abstract state setting unit 31 in the first example embodiment (including modifications, hereinafter the same).

The operation planning means 16X is configured to determine an operation plan relating to a movement of the robot an operation of the manipulator, based on the state set by the state setting means 31X, a constraint condition relating to the movement of the robot and the operation of the manipulator, and an evaluation function based on dynamics of the robot. Examples of the operation planning means 16X include the operation planning unit 16 (excluding the abstract state setting unit 31) in the first example embodiment.

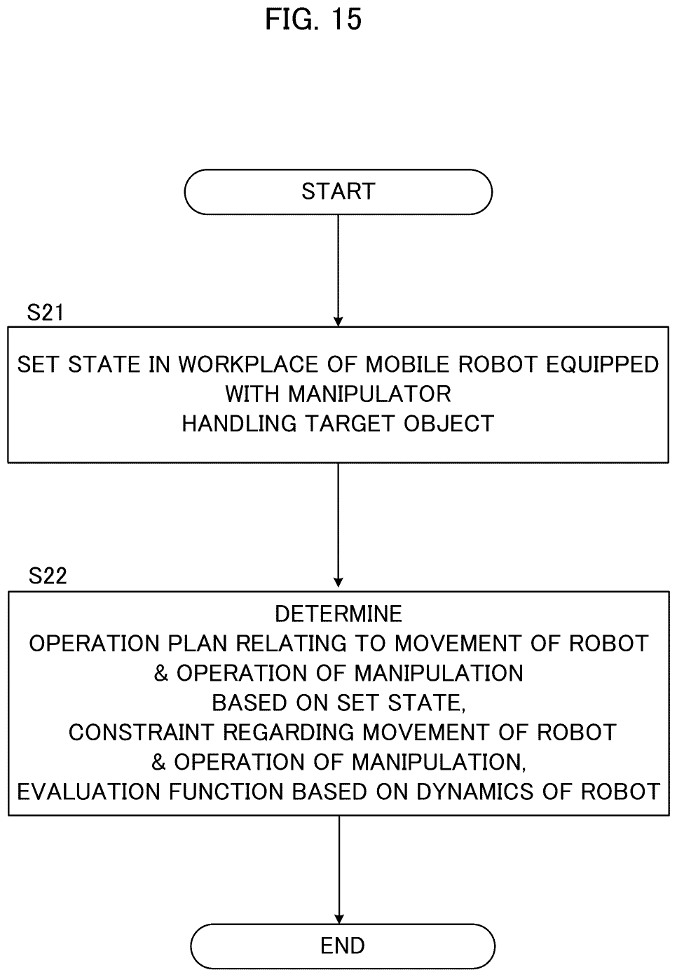

FIG. 15 is an example of a flowchart in the second example embodiment. The state setting means 31X sets a state in a workspace where a mobile robot equipped with a manipulator handling a target object works (step S21). The operation planning means 16X determines an operation plan relating to a movement of the robot an operation of the manipulator, based on the state set by the state setting means 31X, a constraint condition relating to the movement of the robot and the operation of the manipulator, and an evaluation function based on dynamics of the robot (step S22).

According to the second example embodiment, the operation planning device 1X can formulate an optimal operation plan that takes into account both the movement of the mobile robot and the operation of the manipulator of the robot.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

### [Supplementary Note 1]

An operation planning device comprising:
a state setting means configured to set a state in a workspace where a mobile robot equipped with a manipulator handling a target object works; and
an operation planning means configured to determine an operation plan relating to a movement of the robot and an operation of the manipulator, based on
   the state,
   a constraint condition relating to the movement of the robot and the operation of the manipulator, and
   an evaluation function based on dynamics of the robot.

### [Supplementary Note 2]

The operation planning device according to Supplementary Note 1,
wherein the operation planning means is configured to determine
   a first operation plan for moving the robot to a reference point set within a designated area designated as an area where the robot works, and
   a second operation plan that is the operation plan based on
      the state after the robot reaches the reference point,
      the constraint condition, and
      the evaluation function.

### [Supplementary Note 3]

The operation planning device according to Supplementary Note 2,
wherein the operation planning means is configured to set the reference point based on the position of the target object.

### [Supplementary Note 4]

The operation planning device according to Supplementary Note 3,
wherein the operation planning means configured to determine the reference point based on a position of the target object, a movement error of the robot, and a reach range of the manipulator.

### [Supplementary Note 5]

The operation planning device according to any one of Supplementary Notes 2 to 4,
wherein, if the robot reaches the reference point based on the first operation plan,
   the state setting means is configured to determine a state setting space in which at least the robot and the target object are present and set the state within the state setting space.

### [Supplementary Note 6]

The operation planning device according to any one of Supplementary Notes 1 to 5,
wherein, if a priority to be prioritized in determining the operation plan is specified,
   the operation planning means is configured to determine at least one of the constraint condition and/or the evaluation function, based on the priority.

### [Supplementary Note 7]

The operation planning device according to Supplementary Note 6,
wherein, if a work time length is prioritized as the priority,
the operation planning means is configured to set the evaluation function having a positive or negative correlation with the work time length.

### [Supplementary Note 8]

The operation planning device according to Supplementary Note 6,
wherein, if a safety is prioritized as the priority,
the operation planning means is configured to set the constraint condition which requires exclusive executions between movement of the robot and operation of the manipulator.

### [Supplementary Note 9]

The operation planning device according to any one of Supplementary Notes 1 to 8, further comprising:
a logical formula conversion means configured to convert a task to be executed by the robot into a logical formula in a form of a temporal logic, based on the state;
a time step logical formula generation means configured to generate a time step logical formula that is a formula representing the state for each time step to execute the task; and
a subtask sequence generation means configured to generate, as the operation plan, a subtask sequence to be executed by the robot, based on the time step logical formula.

### [Supplementary Note 10]

An operation planning device comprising:
an area designation means configured to receive designation of an area where a mobile robot equipped with a manipulator handling a target object works;
a target designation means configured to receive designation relating to the target object in the area; and
an operation planning means configured to determine an operation plan relating to a movement of the robot and an operation of the manipulator, based on the designation of the area and the designation relating to the target object.

### [Supplementary Note 11]

The operation planning device according to Supplementary Note 10,
wherein the operation planning means is configured to determine
   a first operation plan for moving the robot to a reference point set within a designated area designated as an area where the robot works, and
   a second operation plan that is the operation plan relating to the movement of the robot and the operation of the manipulator after execution of the first operation plan by the robot.

### [Supplementary Note 12]

An operation planning method executed by a computer, the operation planning method comprising:
setting a state in a workspace where a mobile robot equipped with a manipulator handling a target object works; and
determining an operation plan relating to a movement of the robot and an operation of the manipulator, based on
   the state,
   a constraint condition relating to the movement of the robot and the operation of the manipulator, and
   an evaluation function based on dynamics of the robot.

### [Supplementary Note 13]

A storage medium storing a program executed by a computer, the program causing the computer to:
set a state in a workspace where a mobile robot equipped with a manipulator handling a target object works; and
determine an operation plan relating to a movement of the robot and an operation of the manipulator, based on
   the state,
   a constraint condition relating to the movement of the robot and the operation of the manipulator, and
   an evaluation function based on dynamics of the robot.

### [Supplementary Note 14]

An operation planning method executed by a computer, the operation planning method comprising:
is receiving designation of an area where a mobile robot equipped with a manipulator handling a target object works;
receiving designation relating to the target object in the area; and
determining an operation plan relating to a movement of the robot and an operation of the manipulator, based on the designation of the area and the designation relating to the target object.

### [Supplementary Note 15]

A storage medium storing a program executed by a computer, the program causing the computer to:
receive designation of an area where a mobile robot equipped with a manipulator handling a target object works;
receive designation relating to the target object in the area; and
determine an operation plan relating to a movement of the robot and an operation of the manipulator, based on the designation of the area and the designation relating to the target object.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1 Robot controller
1X Operation planning device
2 Instruction device
4 Storage device
5 Robot
7 Sensor
41 Application information storage unit
100 Robot control system

What is claimed is:

1. An operation planning device comprising:
at least one memory configured to store instructions; and
at least one processor configured to execute the instructions to:
set a state in a workspace where a mobile robot equipped with a manipulator handling a target object works; and
determine an operation plan relating to a movement of the robot and an operation of the manipulator, based on
the state,
a constraint condition relating to the movement of the robot and the operation of the manipulator, and
an evaluation function based on dynamics of the robot.

2. The operation planning device according to claim 1,
wherein the at least one processor configured to execute the instructions to determine
a first operation plan for moving the robot to a reference point set within a designated area designated as an area where the robot works, and
a second operation plan that is the operation plan based on
the state after the robot reaches the reference point,
the constraint condition, and
the evaluation function.

3. The operation planning device according to claim 2,
wherein the at least one processor is configured to execute the instructions to set the reference point based on the position of the target object.

4. The operation planning device according to claim 3,
wherein the at least one processor is configured to execute the instructions to determine the reference point based on a position of the target object, a movement error of the robot, and a reach range of the manipulator.

5. The operation planning device according to claim 1,
wherein, if the robot reaches the reference point based on the first operation plan,
the at least one processor is configured to execute the instructions to determine a state setting space in which at least the robot and the target object are present and set the state within the state setting space.

6. The operation planning device according to claim 1,
wherein, if a priority to be prioritized in determining the operation plan is specified,
the at least one processor is configured to execute the instructions to determine at least one of the constraint condition and/or the evaluation function, based on the priority.

7. The operation planning device according to claim 6,
wherein, if a work time length is prioritized as the priority,
the at least one processor is configured to execute the instructions to set the evaluation function having a positive or negative correlation with the work time length.

8. The operation planning device according to claim 6,
wherein, if a safety is prioritized as the priority,
the at least one processor is configured to execute the instructions to set the constraint condition which requires exclusive executions between movement of the robot and operation of the manipulator.

9. The operation planning device according to claim 1,
wherein the at least one processor is configured to further execute the instructions to:
convert a task to be executed by the robot into a logical formula in a form of a temporal logic, based on the state;
generate a time step logical formula that is a formula representing the state for each time step to execute the task; and
generate, as the operation plan, a subtask sequence to be executed by the robot, based on the time step logical formula.

10. An operation planning device comprising:
at least one memory configured to store instructions; and
at least one processor configured to execute the instructions to:
receive designation of an area where a mobile robot equipped with a manipulator handling a target object works;
receive designation relating to the target object in the are; and
determine an operation plan relating to a movement of the robot and an operation of the manipulator, based on the designation of the area and the designation relating to the target object.

11. The operation planning device according to claim 10,
wherein the at least one processor is configured to execute the instructions to determine
a first operation plan for moving the robot to a reference point set within a designated are designated as an area where the robot works, and
a second operation plan that is the operation plan relating to the movement of the robot and the operation of the manipulator after execution of the first operation plan by the robot.

12. An operation planning method executed by a computer, the operation planning method comprising:
setting a state in a workspace where a mobile robot equipped with a manipulator handling a target object works; and
determining an operation plan relating to a movement of the robot and an operation of the manipulator, based on
the state,
a constraint condition relating to the movement of the robot and the operation of the manipulator, and
an evaluation function based on dynamics of the robot.
